(19) United States
(12) Patent Application Publication
(10) Pub. No.: US 2015/0165679 A1
(43) Pub. Date: Jun. 18, 2015

(54) THREE DIMENSIONAL MOLD OBJECT MANUFACTURING APPARATUS, METHOD FOR MANUFACTURING THREE DIMENSIONAL MOLD OBJECT, AND THREE DIMENSIONAL MOLD OBJECT

(71) Applicant: SEIKO EPSON CORPORATION, Tokyo (JP)

(72) Inventor: Junichi GOTO, Matsumoto (JP)

(21) Appl. No.: 14/557,656

(22) Filed: Dec. 2, 2014

(30) Foreign Application Priority Data
Dec. 13, 2013 (JP) 2013-258546

(51) Int. Cl. B29C 67/00

(52) U.S. Cl. CPC B29C 67/0066; B29K 2105/0058

(57) ABSTRACT

A three dimensional mold object manufacturing apparatus is adapted to manufacture a three dimensional mold object by repeatedly forming and layering layers using a composition including particles. The apparatus includes a layer forming section which forms the layers using the composition, a bonded section forming part which bonds the particles included in a predetermined region of the layer and forms a bonded section, and a modifying part which carries out modification processing with regard to the layer where the bonded section is formed before a subsequent layer is formed on the layer where the bonded section is formed.

### CROSS-REFERENCE TO RELATED APPLICATIONS

This application claims priority to Japanese Patent Application No. 2013-258546 filed on Dec. 13, 2013. The entire disclosure of Japanese Patent Application No. 2013-258546 is hereby incorporated herein by reference.

### BACKGROUND

1. Technical Field

The present invention relates to a three dimensional mold object manufacturing apparatus, a method for manufacturing a three dimensional mold object, and a three dimensional mold object.

2. Related Art

A technique is known where a three dimensional mold object is molded by forming a powder layer (a unit layer) using a composition which includes particles (powder) and the powder layers are layered (for example, Japanese Unexamined Patent Application Publication No. H6-218712). With this technique, the three dimensional mold object is molded by the following operations being repeated. First, a powder layer is formed by thinly laying powder with a uniform thickness, and a bonded section is formed by the powder being selectively bonded only at desired portions of the powder layer. As a result, a member with a thin plate shape (referred to below as a “cross sectional member”) is formed at the bonded section where the powder is bonded together. After this, on this powder layer, another powder layer is thinly formed, and a bonded section is formed by the powder being selectively bonded only at desired portions. As a result, a new cross sectional member is formed with the powder layer which is newly formed. At this time, the cross sectional member which is newly formed is also bonded with the cross sectional member which was already formed. By repeating these operations, it is possible to form a three dimensional mold object by layering the cross sectional members with the thin plate shape (the bonded section) one layer at a time.

However, there are cases with this technique where adhesiveness of the powder layer, which is formed directly on the powder layer (the powder layer which has the bonded section) which is already formed, deteriorates. In these cases, there is a problem in that mechanical strength and durability of the three dimensional mold object is reduced since adhesiveness between layers is reduced in the three dimensional mold object.

In addition, there is a problem in that, in a case where the powder layer which is new is formed by applying the composition onto the powder layer where the bonded section is formed, the composition is repelled in places, the composition slips on the bonded section during planarizing, and it is not possible to form the powder layers with highly uniform thickness.

For example, there are cases where the composition which includes a solvent in addition to the particles is used with the object of increasing fluidity of the composition, improving operability when forming the powder layers, preventing unintentional scattering or the like of the particles when forming the powder layers, and the like, but the problems described above are, in particular, remarkably generated in this case.

### SUMMARY

The object of the present invention is to provide a three dimensional mold object manufacturing apparatus where it is possible to efficiently manufacture a three dimensional mold object with superior dimensional precision and superior mechanical strength and durability, to provide a method for manufacturing a three dimensional mold object where it is possible to efficiently manufacture a three dimensional mold object with superior dimensional precision and superior mechanical strength and durability, and to provide a three dimensional mold object which is manufactured using the three dimensional mold object manufacturing apparatus or the method for manufacturing a three dimensional mold object.

This object is achieved using the aspects of the present invention described below.

A three dimensional mold object manufacturing apparatus is adapted to manufacture a three dimensional mold object by repeatedly forming and layering layers using a composition including particles. The three dimensional mold object manufacturing apparatus includes a layer forming section, a bonded section forming part, and a modifying part. The layer forming section is configured and arranged to form the layers using the composition. The bonded section forming part is configured and arranged to bond the particles included in a predetermined region in at least one of the layers to form a bonded section. The modifying part is configured and arranged to carry out modification processing with respect to the at least one of the layers where the bonded section is formed before a subsequent one of the layers is formed on the at least one of the layers.

Due to this, it is possible to provide the three dimensional mold object manufacturing apparatus where it is possible to efficiently manufacture a three dimensional mold object with superior dimensional precision and superior mechanical strength and durability.

In the three dimensional mold object manufacturing apparatus of the aspect, the modifying part preferably has an energy ray irradiating part configured and arranged to irradiate energy rays with respect to the at least one of the layers where the bonded section is formed.

Due to this, it is possible to stably manufacture the three dimensional mold object over a long period of time without performing supplementing of materials for the modification processing. In addition, it is possible to omit or simplify preparation for the modification processing and processing after the modification processing and it is possible for the three dimensional mold object to have particularly superior productivity.

In the three dimensional mold object manufacturing apparatus of the aspect, the energy rays are preferably ultraviolet rays with a peak wavelength of 1 nm or more and 330 nm or less.

Due to this, it is possible to more efficiently perform modifying over a shorter period of time, it is possible for the three dimensional mold object to have particularly superior productivity, and it is possible for the three dimensional mold object to have particularly superior dimensional precision, mechanical strength, durability, and the like. In addition, since active oxygen is efficiently generated by irradiating of ultraviolet rays with this wavelength being performed in an atmosphere which includes oxygen (O₂), an action is exhibited where the ultraviolet rays which are irradiated directly modify the layer configuring material, an action is also exhibited where the layer configuring material is modified due to the active oxygen which is generated by the ultraviolet rays, it is possible to more efficiently perform modifying over an even shorter period of time due to these effects acting in combination, it is possible for the three dimensional mold object to have more superior productivity, and it is possible for the three dimensional mold object to have more superior dimensional precision, mechanical strength, durability, and the like.

In the three dimensional mold object manufacturing apparatus of the aspect, an area of an irradiating region irradiated by an irradiating section for energy rays in the energy ray irradiating part is preferably larger than an area of the at least one of the layers.

Due to this, it is possible to effectively prevent unintentional variation in the extent of the modifying at each portion of the layer from being generated.

In the three dimensional mold object manufacturing apparatus of the aspect, the modifying part preferably has a modifying agent applying part configured and arranged to apply a modifying agent.

Due to this, it is possible to more appropriately perform processing according to the formation of the layer where the modification processing is carried out (the layer where the bonded section is formed) by selecting the type of modifying agent and the like.

In the three dimensional mold object manufacturing apparatus of the aspect, the modifying part is preferably configured and arranged to perform atmospheric pressure plasma processing.

In the three dimensional mold object manufacturing apparatus of the aspect, the bonded section forming part preferably includes a binding liquid applying part configured and arranged to apply a binding liquid for bonding the particles.

Due to this, it is possible to apply the binding liquid with a fine pattern and particularly productively manufacturing is possible even with the three dimensional mold object which has a fine structure.

In the three dimensional mold object manufacturing apparatus of the aspect, the bonded section forming part preferably includes a curing part configured and arranged to cure a curable component included in the binding liquid.

Due to this, it is possible for the bonding strength of the particles in the bonded section and the mechanical strength of the bonded section (the three dimensional mold object) to be particularly superior. In addition, it is easy for problems to be generated such as deteriorating of adhesiveness of the powder layer, which is formed direct on the powder layer (the layer) which has the bonded section, in the prior art in a case where the bonded section includes curable material with the curable component, but it is possible to reliably prevent the problems described above from being generated in the aspect of the present invention even in a case where the bonded section includes the curable material with the curable component. That is, the effects due to the aspect of the present invention are more remarkably exhibited in a case where the bonded section forming part is provided with the curing part, which cures the curable component which is included in the binding liquid, in addition to the binding liquid applying part.

In the three dimensional mold object manufacturing apparatus of the aspect, the modifying part is preferably configured and arranged to carry out the modification processing in a state where the binding liquid applying part is arranged in a space separated from the modifying part so that the binding liquid applying part is not influenced by the modifying part.

Due to this, it is possible to more effectively prevent changes in the properties of the binding liquid which is applied by the binding liquid applying part due to the influence of the modification processing using the modifying part and it is possible to perform more stable discharging of liquid droplets and manufacturing of the three dimensional mold object over a long period of time.

The three dimensional mold object manufacturing apparatus of the aspect preferably further includes a scanning part configured and arranged to scan a state of the at least one of the layers where the modification processing is carried out.

Due to this, it is possible to check whether or not the modification processing is appropriately performed on the layer and it is possible perform additional modification processing according to requirements. As a result, it is possible to more productively and more reliably manufacture a three dimensional mold object with superior dimensional precision and superior mechanical strength and durability.

In the three dimensional mold object manufacturing apparatus of the aspect, the composition preferably includes a volatile solvent and a water soluble resin in addition to the particles.

Due to this, the particles are bonded (temporary fixed) together in portions of the layer where the binding liquid is not applied, it is possible to effectively prevent unintentional scattering and the like of the particles, and it is possible to achieve an improvement in the safety of an operator and dimensional precision of the three dimensional mold object which is manufactured. In addition, it is possible for fluidity of the composition to be particularly superior and it is possible for the three dimensional mold object to have particularly superior productivity. In addition, in a case where the composition for forming layers includes the solvent in addition to the particles (the powder), problems are particularly remarkably generated in the prior art such that, when the layer which is new is formed by applying the composition onto the layer where the bonded section is formed, the composition is repelled in places, the composition slips on the bonded section during planarizing, and it is not possible to form the powder layers with highly uniform thickness, but it is possible to reliably prevent these problems from being generated in the aspect of the present invention. That is, the effects of the aspect of the present invention are more remarkably exhibited in a case where the composition includes the volatile solvent in addition to the particles.

In the three dimensional mold object manufacturing apparatus of the aspect, the particles are preferably porous and subject to hydrophobic processing.

Due to this, in a case where the binding liquid includes a bonding agent which is hydrophobic, it is possible for the bonding agent which is hydrophobic to appropriately penetrate inside porous holes and for an anchor effect to be exhibited when manufacturing the three dimensional mold object, and as a result, it is possible to have a superior bonding force to bond together the particles (a bonding force using the bonding agent) and it is possible to appropriately manufacture the three dimensional mold object with superior mechanical strength as a result. In addition, due to the bonding agent which configures the binding liquid entering into the porous holes of the particles, it is possible to effectively prevent unintentional wet spreading of the binding liquid. As a result, it is possible for the three dimensional mold object which is obtained as a final result to have even higher dimensional precision. In addition, in a case where the particles which are porous and are subject to hydrophobic processing are used in a method where modification processing is not carried out with respect to the layer where the bonded section is formed, it is particularly easy for problems to be generated such as deteriorating of adhesiveness of the layer which is formed directly on the layer which has the bonded section, but it is possible to reliably prevent the problems described above from being generated in the aspect of the present invention even in a case where the particles which are porous and are subject to hydrophobic processing are used. That is, the effects of the aspect of the present invention are more remarkably exhibited in a case where the particles which are porous and are subject to hydrophobic processing are used.

A method for manufacturing a three dimensional mold object of another aspect includes manufacturing the three dimensional mold object using the three dimensional mold object manufacturing apparatus according to the above described aspects.

Due to this, it is possible to provide the method for manufacturing a three dimensional mold object where it is possible to efficiently manufacture a three dimensional mold object with superior dimensional precision and superior mechanical strength and durability.

A method for manufacturing a three dimensional mold object according to another aspect includes: forming a layer with a predetermined thickness using a composition including particles; bonding the particles included in a predetermined region of the layer and forming a bonded section; repeating the forming and the bonding to form a plurality of the layers constituting the three dimensional mold object; and carrying out modification processing with respect to at least one of the layers where the bonded section is formed after the bonding of the particles in the at least one of the layers and before the forming of a subsequent one of the layers on a surface of the at least one of the layers where the bonded section is formed.

Due to this, it is possible to provide the method for manufacturing a three dimensional mold object where it is possible to efficiently manufacture a three dimensional mold object with superior dimensional precision and superior mechanical strength and durability.

In the method for manufacturing a three dimensional mold object of the aspect, the bonding preferably includes applying a binding liquid including a bonding agent, with respect to the at least one of the layers using an ink jet system and curing the bonding agent in the binding liquid applied to the layer.

Due to this, it is possible to apply the binding liquid with favorable reproduction even when patterns for applying the binding liquid are fine shapes, it is possible for the three dimensional mold object which is obtained as a final product to have particularly high dimensional precision, it is possible for the bonding strength of the bonding agent and the particles to be particularly superior, and it is possible for the three dimensional mold object which is obtained as a final product to have particularly superior mechanical strength as a result.

A three dimensional mold object of another aspect is manufactured using the three dimensional mold object manufacturing apparatus of the above described aspects.

Due to this, it is possible to provide the three dimensional mold object with superior dimensional precision and superior mechanical strength and durability.

### BRIEF DESCRIPTION OF THE DRAWINGS

Referring now to the attached drawings which form a part of this original disclosure:

FIGS. 1A to 1E are cross sectional diagrams schematically illustrating each process in an appropriate embodiment of a method for manufacturing a three dimensional mold object of the present invention.

FIGS. 2A to 2E are cross sectional diagrams schematically illustrating each process in an appropriate embodiment of a method for manufacturing a three dimensional mold object of the present invention.

FIG. 3 is a cross sectional diagram schematically illustrating an appropriate embodiment of a three dimensional mold object manufacturing apparatus of the present invention.

FIG. 4 is a cross sectional diagram illustrating a state in the three dimensional mold object manufacturing apparatus shown in FIG. 3 where a space where there is a binding liquid discharging section and a space where there is a modifying part are separated.

FIG. 5 is a cross sectional diagram schematically illustrating another appropriate embodiment of a three dimensional mold object manufacturing apparatus of the present invention.

FIG. 6 is a planar diagram illustrating the relationship between a bonded section forming region, which configures a three dimensional mold object which is the object, and a scanning pattern forming region in a region for forming a layer.

FIG. 7 is a diagram for describing a configuration of a first modifying part of a three dimensional mold object manufacturing apparatus.

FIG. 8 is a cross sectional diagram schematically illustrating a state in a layer (a particle-containing composition) immediately before a composition applying process.

FIG. 9 is a cross sectional diagram schematically illustrating a state where particles are bonded together using a binding agent which is hydrophobic.

### DETAILED DESCRIPTION OF EXEMPLARY EMBODIMENTS

Appropriate embodiments of the present invention will be described in detail below with reference to the attached diagrams.

### Method for Manufacturing Three Dimensional Mold Object

A method for manufacturing a three dimensional mold object of the present invention will be described first.

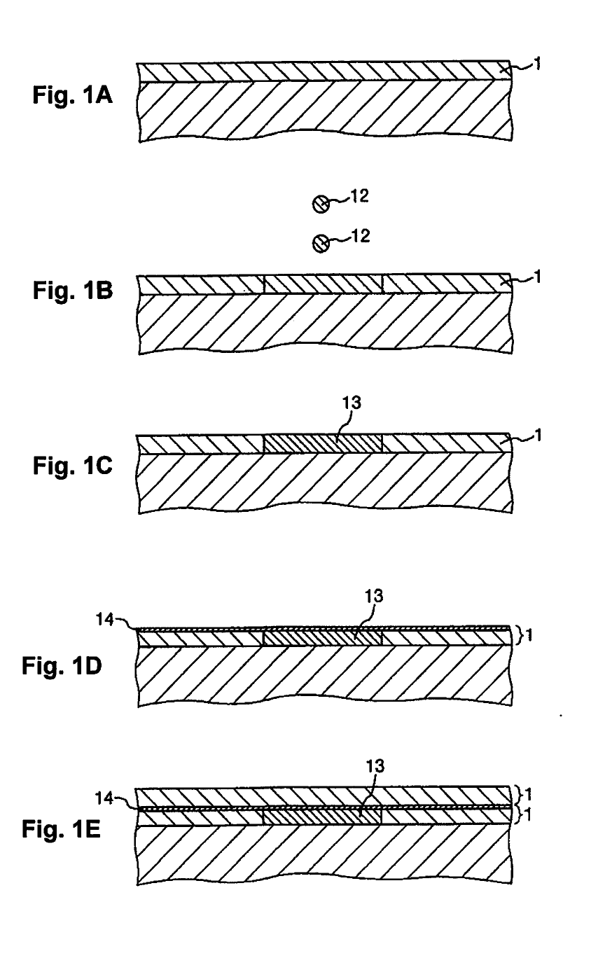

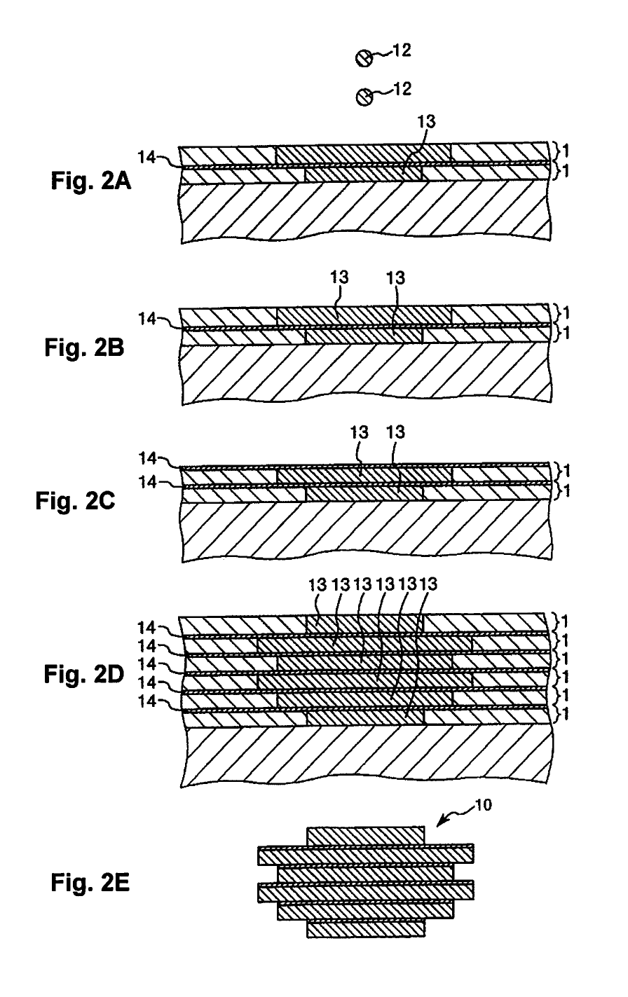

FIGS. 1A to 1E and FIGS. 2A to 2E are cross sectional diagrams schematically illustrating each process in an appropriate embodiment of a method for manufacturing a three dimensional mold object of the present invention.

As shown in FIGS. 1A to 1E and FIGS. 2A to 2E, the manufacturing method of the present embodiment has a layer forming process (1A and 1E) of forming a layer 1 with a predetermined thickness using a composition 11 which includes particles 111, a bonding process (1B, 1C, 2A, and 2B) of bonding the particles 111 which are included in a predetermined region of the layer 1 and forming a bonded section 13, and a modifying process (1D and 2C) of carrying out modification processing with respect to the layer 1 where the bonded section 13 is formed and forming a modified section 14, these processes are repeatedly performed in this order (here, the modifying process is not performed with respect to the layer 1 which is formed in the final layer forming process), and furthermore, after this, the manufacturing method of the present embodiment has an unbonded particles removing process (2E) of removing the particles 111 other than the bonded section 13 out of the particles 111 which configure each of the layers 1.

In this manner, due to the modification processing with respect to the layer 1 (the layer 1 which is already formed) (a first layer) where the bonded section 13 is formed being carried out prior to forming the layer 1 (a second layer) which is new on the layer 1 (the first layer) where the bonded section 13 is formed, it is possible for adhesiveness of the layer 1 (the second layer), which is formed directly on the layer 1 (the first layer) which is already formed and which has the bonded section 13, to be reliably superior and it is possible to reliably prevent unintentional repelling, slipping, or the like of the composition 11 which is applied onto the layer 1 when manufacturing a three dimensional mold object 10. For this reason, it is possible for the three dimensional mold object 10 which is obtained as a final product to have superior mechanical strength and durability. In addition, it is possible to reliably form the layer 1 (the second layer) which is new with highly uniform thickness when forming the layer 1 (the second layer) which is new directly on the layer 1 (the first layer) which is already formed and which has the bonded section 13. As a result, it is possible for the three dimensional mold object 10 which is obtained as a final product to have high dimensional precision and it is possible for unintentional defects and the like to be effectively prevented from being generated. Due to the above, it is possible to obtain the three dimensional mold object 10 which is highly reliable.

In addition, the terms of the “first layer” and the “second layer” in the present invention indicate a relative relationship between any two layers out of the plurality of layers which configure the three dimensional mold object. In more detail, in a relationship where the modification processing is performed for an n^{th} layer of the layer 1, the n^{th} layer of the layer 1 is the “first layer” and an n+1^{th} layer of the layer 1 is the “second layer”, and in a relationship where the modification processing is performed for the n+1^{th} layer of the layer 1 which follows, the n+1^{1h} layer of the layer 1 is the “first layer” and an n+2^{th} layer of the layer 1 is the “second layer”.

In particular, the bonding process (1B, 1C, 2A, and 2B) in the present invention includes a binding liquid applying process (1B and 2A) of applying a binding liquid 12 with respect to the layer 1 using an ink jet system and a curing process (1C and 2B) of forming the bonded section (cured section) 13 in the layer 1 by curing a bonding agent 121 which is included in the binding liquid 12 which is applied to the layer 1 and bonding the particles 111. Due to this, it is possible to apply the binding liquid 12 with favorable reproduction even when patterns for applying the binding liquid 12 are fine shapes, it is possible for the three dimensional mold object 10 which is obtained as a final product to have particularly high dimensional precision, it is possible for the bonding strength of the bonding agent 121 and the particles 111 to be particularly superior, and it is possible for the three dimensional mold object 10 which is obtained as a final product to have particularly superior mechanical strength as a result.

Each of the processes will be described below.

### Layer Forming Process

The layer 1 is formed with a predetermined thickness using the composition (a particle-containing composition) 11 which includes the particles 111 in the layer forming process (1A and 1E).

In particular, the layer 1 is formed with a predetermined thickness on a stage 41 using the composition (the particle-containing composition) 11 which includes the particles 111 in a first layer forming process (1A) and the layer 1 which is new is formed with a predetermined thickness on the layer 1 (the layer 1 where the bonded section 13 is formed) using the composition (the particle-containing composition) 11 which includes the particles 111 in a second and future layer forming processes (1E).

Here, the composition 11 will be described in detail later.

In this process, the layer 1 is formed by the surface being planarized using a planarizing part.

The thickness of the layer 1 which is formed in this process is not particularly limited, is preferably, for example, 30 μm or more and 500 μm or less, and is more preferably 70 μm or more and 150 μm or less. Due to this, it is possible for the three dimensional mold object 10 to have sufficiently superior productivity, for unintentional irregularities and the like to be more effectively prevented from being generated in the three dimensional mold object 10 which is manufactured, and for the three dimensional mold object 10 to have particularly superior dimensional precision.

Here, the particle-containing composition 11 may be in a state of being melted due to heating and having fluidity prior to forming of the layers in a case where, for example, the particle-containing composition 11 are in a solid state (in pellet form) (for example, in a case where particle-containing composition 11 includes a water soluble resin (thermoplastic resin) 112 which is in a solid state at a temperature which is close to the storage temperature (for example, room temperature (25° C.)) and is in a state where a plurality of the particles 111 are bonded using the water soluble resin 112). Due to this, it is possible to effectively perform forming of the layers using a simple method and it is possible to more effectively prevent unintentional variation in the thickness of the layers 1 which are formed. As a result, it is possible to manufacture the three dimensional mold object 10 to have more dimensional precision with higher productivity.

The modifying process (a first modifying process) where modification processing is carried out with respect to the layer 1 where the binding liquid is not applied may be performed prior to the bonding process (the binding liquid applying process and the curing process) which will be described later.

The first modifying process will be described in detail later.

### Binding Liquid Applying Process

After the layer 1 is formed in the layer forming process, the binding liquid 12 for bonding the particles 111 which configure the layer 1 is applied with respect to the layer 1 using an ink jet system (1B and 2A).

In this process, the binding liquid 12 is selectively applied to portions of the layer 1 which correspond to actual sections (portions which are to be solid) of the three dimensional mold object 10.

Due to this, it is possible to strongly bond together the particles 111 which configure the layer 1 and to form the bonded section (cured section) 13 with a desired shape as a final product. In addition, it is possible for the three dimensional mold object 10 which is obtained as a final product to have superior mechanical strength.

In this process, it is possible to apply the binding liquid 12 with favorable reproduction even when patterns for applying the binding liquid 12 are fine shapes since the binding liquid 12 is applied using an ink jet system. As a result, it is possible for the three dimensional mold object 10 which is obtained as a final product to have particularly high dimensional precision.

Here, the binding liquid 12 will be described later.

### Curing Process (Bonding Process)

After applying of the binding liquid 12 to the layer 1 in the binding liquid applying process, the bonding agent 121, which is included in the binding liquid 12 which is applied to the layer 1, is cured and the bonded section (the cured section) 13 is formed (1C and 2B). Due to this, it is possible to have particular superior bonding strength between the bonding agent 121 and the particles 111, and as a result, it is possible for the three dimensional mold object 10 which is obtained as a final product to have particular superior mechanical strength.

This process differs depending on the type of the bonding agent 121, and, for example, it is possible to be performed by heating in a case where the bonding agent 121 is thermosetting resin and it is possible to be performed by irradiating with the corresponding light in a case where the bonding agent 121 is photocurable resin (for example, it is possible to be performed by irradiating ultraviolet rays in a case where the bonding agent 121 is an ultraviolet ray curable resin).

Here, the binding liquid applying process and the curing process may be performed so as to progress at the same time. That is, a curing reaction may progress sequentially from a portion where the binding liquid 12 is applied before the whole pattern of the entirety of one of the layers 1 is formed.

In addition, it is possible for this process to be omitted in a case where, for example, the bonding agent 121 does not have a curable component. In this case, the binding liquid applying process described above may also act as the bonding process.

### Modifying Process (Second Modifying Process)

The modification processing (second modification processing) is performed with respect to the layer 1 where the bonded section (the cured section) 13 is formed in the modifying process (a second modifying process) (1D and 2C). Due to this, it is possible to form the modified section 14 due to the second modification processing and it is possible for adhesiveness of the layer 1 (the second layer), which is formed directly on the layer 1 (the first layer) where the bonded section (the cured section) 13 is formed, to be reliably superior. For this reason, it is possible for the three dimensional mold object 10 which is obtained as a final product to have superior mechanical strength and durability. In addition, it is possible to reliably form the layer 1 (the second layer) which is new with highly uniform thickness when forming the layer 1 (the second layer) which is new directly on the layer 1 (the first layer) where the bonded section (the cured section) 13 is formed. As a result, it is possible for the three dimensional mold object 10 which is obtained as a final product to have high dimensional precision and it is possible for unintentional defects and the like to be reliably prevented from being generated. Due to the above, it is possible to obtain the three dimensional mold object 10 which is highly reliable. Here, in the configuration shown in the diagrams, the modified section 14 is only formed in regions on the surface side of the layer 1 due to only a portion of the layer 1 in the thickness direction being modified, but the modified section 14 may be formed (up to the deepest portion of the layer 1) over the entirety of the layer 1 in the thickness direction by the entirety of the layer 1 in the thickness direction being modified in this process.

As a specific method for the modification processing (the second modification processing), there are the examples of, for example, irradiating of energy rays, applying a modifying agent, corona processing, plasma processing, and the like and it is possible to perform one type or a combination of two or more types of the methods which are selected from these.

In a case where the modification processing (the second modification processing) is performing by irradiating energy rays, a hydrophilic group is generated on the layer 1. Due to this, adhesiveness with the layer 1 which is formed afterwards is improved.

In a case where the modification processing (the second modification processing) is performing by applying a modifying agent, a plasma effect is realized using the modifying agent and, due to this, adhesiveness with the layer 1 which is formed afterwards is improved.

As the energy rays, there are the examples of, for example, ultraviolet rays, visible light rays, infrared rays, X rays, γ rays, electron rays, ion beams, and the like.

In a case where the modifying process (the second modifying process) is performing by applying a modifying agent, applying of a modifying agent may be performed with a gas phase (for example, exposing the layer 1 in an atmosphere which includes the modifying agent which is evaporated or the like) or may be performed with a liquid phase (a method of spraying the layer 1 with a composition in liquid form which includes the modifying agent, using waste cloth or the like which is immersed in a composition in liquid form which includes the modifying agent and coating the composition over the layer 1 or the like).

In a case where applying of the modifying agent is performed with a gas phase, it is possible to easily and reliably prevent excessive modifying agent adhering to the layer 1. In addition, it is possible to more effectively prevent or suppress unintentional variation in the amount adhering to each portion of the layer 1. In addition, it is possible to omit or simplify processing for drying after the modification processing.

In a case where applying of the modifying agent is performed with a liquid phase, it is possible for the three dimensional mold object 10 to have particularly superior productivity since it is possible to omit or simplify an operation for replacing the atmosphere when performing following processes (the layer forming process) after the modification processing (the second modification processing).

In addition, as the modifying agent, there are the examples of, for example, a silane coupling agent or the like.

As the silane coupling agent, it is possible to use, for example, a silane compound which includes a silyl group, and it is possible for there to be the specific examples of, for example, hexamethyl disilazane, dimethyl dimethoxy silane, diethyl diethoxy silane, 1-propenyl methyl dichloro silane, propyl dimethyl chloro silane, propyl methyl dichloro silane, propyl trichloro silane, propyl triethoxy silane, propyl trimethoxy silane, styrylethyl trimethoxy silane, tetradecyl trichloro silane, 3-thiocyanate propyl triethoxy silane, p-tolyl dimethyl chloro silane, p-tolyl methyl dichloro silane, p-tolyl trichloro silane, p-tolyl trimethoxy silane, p-tolyl triethoxy silane, di-n-propyl di-n-propoxy silane, diisopropyl diisopropoxy silane, di-n-butyl di-n-butyloxy silane, di-sec-butyl di-sec-butyloxy silane, di-t-butyl di-t-butyloxy silane, octadecyl trichloro silane, octadecyl methyl diethoxy silane, octadecyl triethoxy silane, octadecyl trimethoxy silane, octadecyl dimethyl chloro silane, octadecyl methyl dichloro silane, octadecyl methoxy dichloro silane, 7-octenyl dimethyl chloro silane, 7-octenyl trichloro silane, 7-octenyl trimethoxy silane, octylmethyl dichloro silane, octyldimethyl chloro silane, octyl trichloro silane, 10-undecenyl dimethyl chloro silane, undecyl trichloro silane, vinyldimethyl chloro silane, methyl octadecyl dimethoxy silane, methyl dodecyl diethoxy silane, methyl octadecyl silane, methyl octadecyl diethoxy silane, n-octyl methyl dimethoxy silane, n-octyl methyl diethoxy silane, triacontyl dimethyl chloro silane, triacontyl trichloro silane, methyl trimethoxy silane, methyl triethoxy silane, methyl tri-n-propoxy silane, methyl isopropoxy silane, methyl-n-butyloxy silane, methyl tri-sec-butyloxy silane, methyl tri-t-butyloxy silane, ethyl trimethoxy silane, ethyl triethoxy silane, ethyl tri-n-propoxy silane, ethyl isopropoxy silane, ethyl-n-butyloxy silane, ethyl tri-sec-butyloxy silane, ethyl tri-t-butyloxy silane, n-propyl trimethoxy silane, isobutyl trimethoxy silane, n-hexyl trimethoxy silane, hexadecyl trimethoxy silane, n-octyl trimethoxy silane, n-dodecyl trimethoxy silane, n-octadecyl trimethoxy silane, n-propyl triethoxy silane, isobutyl triethoxy silane, n-hexyl triethoxy silane, hexadecyl triethoxy silane, n-octyl triethoxy silane, n-dodecyl trimethoxy silane, n-octadecyl triethoxy silane, 2-[2-(trichlorosilyl)ethyl]pyridine, 4-[2-(trichlorosilyl)ethyl]pyridine, diphenyl dimethoxy silane, diphenyl diethoxy silane, 1,3(trichlorosilyl methyl)heptacosane, dibenzyl dimethoxy silane, dibenzyl diethoxy silane, phenyl trimethoxy silane, phenyl methyl dimethoxy silane, phenyl dimethyl methoxy silane, phenyl dimethoxy silane, phenyl diethoxy silane, phenyl methyl diethoxy silane, phenyl dimethyl ethoxy silane, benzyl triethoxy silane, benzyl trimethoxy silane, benzyl methyl dimethoxy silane, benzyl dimethyl methoxy silane, benzyl dimethoxy silane, benzyl diethoxy silane, benzyl methyl diethoxy silane, benzyl dimethyl ethoxy silane, benzyl triethoxy silane, dibenzyl dimethoxy silane, dibenzyl ethoxy silane, 3-acetoxy propyl trimethoxy silane, 3-acryloxy propyl trimethoxy silane, allyl trimethoxy silane, allyl triethoxy silane, 4-aminobutyl triethoxy silane, (aminoethyl aminomethyl)phenethyl trimethoxy silane, N-(2-aminoethyl)-3-aminopropyl methyl dimethoxy silane, N-(2-aminoethyl)-3-aminopropyl trimethoxy silane, 6-(aminohexyl aminopropyl)trimethoxy silane, p-aminophenyl trimethoxy silane, p-aminophenyl ethoxy silane, m-aminophenyl trimethoxy silane, m-aminophenyl ethoxy silane, 3-aminopropyl trimethoxy silane, 3-aminopropyl triethoxy silane, w-amino undecyl trimethoxy silane, amyl triethoxy silane, benzoxa silepin dimethyl ester, 5-(bicycle heptenyl)triethoxy silane, bis(2-hydroxy ethyl)-3-aminopropyl triethoxy silane, 8-bromooctyl trimethoxy silane, bromophenyl trimethoxy silane, 3-bromopropyl trimethoxy silane, n-butyl trimethoxy silane, 2-chloromethyl triethoxy silane, chloromethyl methyl diethoxy silane, chloromethyl methyl diisopropoxy silane, p-(chloromethyl)phenyl trimethoxy silane, chloromethyl triethoxy silane, chlorophenyl triethoxy silane, 3-chloropropyl methyl dimethoxy silane, 3-chloropropyl triethoxy silane, 3-chloropropyl trimethoxy silane, 2-(4-chlorosulfonyl phenyl)ethyl trimethoxy silane, 2-cyanoethyl triethoxy silane, 2-cyanoethyl trimethoxy silane, cyanomethyl phenethyl trimethoxy silane, 3-cyanopropyl triethoxy silane, 2-(3-cyclohexenyl)ethyl trimethoxy silane, 2-(3-cyclohexenyl)ethyl triethoxy silane, 3-cyclohexenyl trichloro silane, 2-(3-cyclohexenyl)ethyl trichloro silane, 2-(3-cyclohexenyl)ethyl chloro dimethyl silane, 2-(3-cyclohexenyl)ethyl methyl dichloro silane, cyclohexyl dimethyl chloro silane, cyclohexyl ethyl dimethoxy silane, cyclohexyl methyl dichloro silane, cyclohexyl methyl dimethoxy silane, (cyclohexyl methyl)trichloro silane, cyclohexyl trichloro silane, cyclohexyl trimethoxy silane, cyclooctyl trichloro silane, (4-cyclooctenyl)trichloro silane, cyclopentyl trichloro silane, cyclopentyl trimethoxy silane, 1,1-diethoxy-1-silacyclo pentadiene-3-ene, 3-(2,4-dinitro phenyl)propyl triethoxy silane, (dimethyl chlorosilyl)methyl-7,7-dimethyl norpinane, (cyclohexyl aminomethyl)methyl diethoxy silane, (3-cyclopenta dienylpropyl)triethoxy silane, N,N-diethyl-3-aminopropyl trimethoxy silane, 2-(3,4-epoxy cyclohexyl)ethyl trimethoxy silane, 2-(3,4-epoxy cyclohexyl)ethyl triethoxy silane, (furfuryloxy methyl)triethoxy silane, 2-hydroxy-4-(3-triethoxy propoxy)diphenyl ketone, 3-(p-methoxy phenyl)propyl methyl dichloro silane, 3-(p-methoxy phenyl)propyl trichloro silane, p-(methyl phenethyl)methyl dichloro silane, p-(methyl phenethyl)trichloro silane, p-(methyl phenethyl)dimethyl chloro silane, 3 morpholinopropyl trimethoxy silane, (3-glycidoxy propyl)methyl diethoxy silane, 3-glycidoxy propyl trimethoxy silane, 1,2,3,4,7,7-hexachloro-6-methyl diethoxy silyl-2-norbornene, 1,2,3,4,7,7-hexachloro-6-triethoxy silyl-2-norbornene, 3-iodopropyl trimethoxy silane, 3-isocyanato propyl triethoxy silane, (mercapto methyl)methyl diethoxy silane, 3-mercapto propyl methyl dimethoxy silane, 3-mercapto propyl dimethoxy silane, 3-mercapto propyl triethoxy silane, 3-methacryloxy propyl methyldiethoxy silane, 3-methacryloxy propyl trimethoxy silane, methyl{2-(3-trimethoxy silyl propylamino)ethylamino}-3-propionate, 7-octenyloxy trimethoxy silane, R—N-α-phenethyl-N′-triethoxy silyl propyl urea, S—N-α-phenethyl-N′-triethoxy silyl propyl urea, phenethyl trimethoxy silane, phenethyl methyl dimethoxy silane, phenethyl dimethyl methoxy silane, phenethyl dimethoxy silane, phenethyl diethoxy silane, phenethyl methyl diethoxy silane, phenethyl dimethyl ethoxy silane, phenethyl triethoxy silane, (3-phenylpropyl)dimethyl chloro silane, (3-phenylpropyl)methyl dichloro silane, N-phenyl aminopropyl trimethoxy silane, N-(triethoxy silyl propyl)dansylamide, N-(3-triethoxy silyl propyl)-4,5-dihydroimidazole, 2-(triethoxy silyl ethyl)-5-(chloro acetoxy) bicycloheptane, (S)—N-triethoxy silyl propyl-O-mentho carbamate, 3-(triethoxy silyl propyl)-p-nitrobenzamide, 3-(triethoxy silyl)propyl succinic anhydride, N-[5-(trimethoxy silyl)-2-aza-1-oxo-pentyl]caprolactam, 2-(trimethoxy silyl ethyl)pyridine, N-(trimethoxy silyl ethyl)benzyl-N,N,N-trimethyl ammonium chloride, phenyl vinyl diethoxy silane, 3-thiocyanate propyl triethoxy silane, (tridecafluoro 1,1,2,2-tetrahydrooctyl)triethoxy silane, N-{3-(triethoxy silyl)propyl}phthalamide acid, (3,3,3-trifluoropropyl)methyl dimethoxy silane, (3,3,3-trifluoropropyl)trimethoxy silane, 1-trimethoxy silyl-2-(chloromethyl)phenyl ethane, 2-(trimethoxy silyl)ethyl phenyl sulfonyl azide, β-trimethoxy silyl ethyl-2-pyridine, trimethoxy silyl propyl diethylene triamine, N-(3-trimethoxy silyl propyl)pyrrole, N-trimethoxy silyl propyl-N,N,N-tributyl ammonium bromide, N-trimethoxy silyl propyl-N,N,N-tributyl ammonium chloride, N-trimethoxy silyl propyl-N,N,N-trimethyl ammonium chloride, vinyl methyl diethoxy silane, vinyl triethoxy silane, vinyl trimethoxy silane, vinyl methyl dimethoxy silane, vinyl dimethyl methoxy silane, vinyl dimethyl ethoxy silane, vinyl methyl dichloro silane, vinyl phenyl dichloro silane, vinyl phenyl diethoxy silane, vinyl phenyl dimethyl silane, vinyl phenyl methyl chloro silane, vinyl triphenoxy silane, vinyl tris-t-butoxy silane, adamantylethyl trichloro silane, allyl phenyl trichloro silane, (aminoethyl aminomethyl)phenethyl trimethoxy silane, 3-aminophenoxy dimethyl vinyl silane, phenyl trichloro silane, phenyl dimethyl chloro silane, phenyl methyl dichloro silane, benzyl trichloro silane, benzyl dimethyl chloro silane, benzyl methyl dichloro silane, phenethyl diisopropyl chloro silane, phenethyl trichloro silane, phenethyl dimethyl chloro silane, phenethyl methyl dichloro silane, 5-(bicycloheptenyl)trichloro silane, 5-(bicycloheptenyl)triethoxy silane, 2-(bicycloheptyl)dimethyl chloro silane, 2-(bicycloheptyl)trichloro silane, 1,4-bis(trimethoxy silyl ethyl)benzene, bromophenyl trichloro silane, 3-phenoxypropyl dimethyl chloro silane, 3-phenoxypropyl trichloro silane, t-butyl phenyl chloro silane, t-butyl phenyl methoxy silane, t-butyl phenyl dichloro silane, p-(t-butyl)phenethyl dimethyl chloro silane, p-(t-butyl)phenethyl trichloro silane, 1,3-(chlorodimethyl silyl methyl)heptacosane, ((chloromethyl) phenyl ethyl)dimethyl chloro silane, ((chloromethyl)phenyl ethyl)methyl dichloro silane, ((chloromethyl)phenylethyl)trichloro silane, ((chloromethyl)phenylethyl)trimethoxy silane, chlorophenyl trichloro silane, 2-cyanoethyl trichloro silane, 2-cyanoethyl methyl dichloro silane, 3-cyanopropyl methyl diethoxy silane, 3-cyanopropyl methyl dichloro silane, 3-cyanopropyl methyl dichloro silane, 3-cyanopropyl dimethyl ethoxy silane, 3-cyanopropyl methyl dichloro silane, 3-cyanopropyl trichloro silane, fluorinated alkyl silane, and the like and it is possible to use one type or a combination of two or more types which are selected from these.

Here, the modification processing (the second modification processing) may be performed with respect to the entirety of the layer 1 (the first layer) or may be selectively performed with respect to a portion of the layer 1 (the first layer) (for example, a region where the bonded section 13 is provided).

In addition, the modification processing (the second modification processing) may be performed while scanning whether or not the modification processing is appropriately performed on the layer 1 (the layer 1 where the bonded section 13 is formed). Due to this, it is possible to perform the modification processing to a necessarily sufficient extent by performing additional modification processing in a case where, for example, the modification processing which is carried out on the layer 1 is insufficient.

### Modifying Process (First Modifying Process)

The modification processing (first modification processing) may performed (a first modifying process) to control penetration of the binding liquid 12 with respect to the layer 1 (the layer 1 where the binding liquid 12 is not applied) prior to the bonding process (the binding liquid applying process and the curing process) as described above.

Due to this, appropriate penetration of the binding liquid 12 is possible with respect to the layer 1 and it is possible to more reliably prevent excessive wetting, repelling, or the like of the binding liquid 12 with respect to the layer 1 and to more reliable form the bonded section 13 with a desired pattern. In addition, it is possible for the binding liquid 12 to more appropriately penetrate to the inner section (a deep section in the thickness direction) of the layer 1 and it is possible for the three dimensional mold object 10 which is obtained as a final product to have superior mechanical strength and durability.

The first modifying process may be performed after the layer forming process and before the bonding process (the binding liquid applying process and the curing process) or may be performed so as to progress at the same time as the layer forming process. That is, the modification processing may be carried out with respect to the composition (the particle-containing composition) 11 while planarizing the composition 11 which is included using a planarizing part.

As a specific method for the first modification processing, there are the examples of, for example, irradiating of energy rays, applying a modifying agent, corona processing, plasma processing, and the like and it is possible to perform one type or a combination of two or more types of the methods which are selected from these.

As the energy rays, there are the examples of, for example, ultraviolet rays, visible light rays, infrared rays, X rays, γ rays, electron rays, ion beams, and the like.

In a case where the first modifying process is performing by applying a modifying agent, applying of a modifying agent may be performed with a gas phase (for example, exposing the layer 1 in an atmosphere which includes the modifying agent which is evaporated or the like) or may be performed with a liquid phase (a method of spraying the layer 1 with a composition in liquid form which includes the modifying agent, using waste cloth or the like which is immersed in a composition in liquid form which includes the modifying agent and coating a composition over the layer 1 or the like).

In a case where applying of the modifying agent is performed with a gas phase, it is possible to easily and reliably prevent excessive modifying agent adhering to the layer 1. In addition, it is possible to more effectively prevent or suppress unintentional variation in the amount adhering to each portion of the layer 1. In addition, it is possible to omit or simplify processing for drying after the modification processing. In addition, it is possible for the binding liquid 12 to more appropriately penetrate to the inner section (a deep section in the thickness direction) of the layer 1 since it is possible to increase penetration of the modifying agent into the layer 1 and it is possible for the three dimensional mold object 10 which is obtained as a final product to have superior mechanical strength and durability.

In a case where applying of the modifying agent is performed with a liquid phase, it is possible for the three dimensional mold object 10 to have particularly superior productivity since it is possible to omit or simplify an operation for replacing the atmosphere when performing following processes after the first modification processing.

In addition, as the modifying agent, there are the examples of, for example, a silane coupling agent, a surfactant, or the like.

As the silane coupling agent, it is possible to use a silane compound which includes a silyl group, and it is possible for there to be the specific examples of, for example, hexamethyl disilazane, dimethyl dimethoxy silane, diethyl diethoxy silane, 1-propenyl methyl dichloro silane, propyl dimethyl chloro silane, propyl methyl dichloro silane, propyl trichloro silane, propyl triethoxy silane, propyl trimethoxy silane, styrylethyl trimethoxy silane, tetradecyl trichloro silane, 3-thiocyanate propyl triethoxy silane, p-tolyl dimethyl chloro silane, p-tolyl methyl dichloro silane, p-tolyl trichloro silane, p-tolyl trimethoxy silane, p-tolyl triethoxy silane, di-n-propyl di-n-propoxy silane, diisopropyl diisopropoxy silane, di-n-butyl di-n-butyloxy silane, di-sec-butyl di-sec-butyloxy silane, di-t-butyl di-t-butyloxy silane, octadecyl trichloro silane, octadecyl methyl diethoxy silane, octadecyl triethoxy silane, octadecyl trimethoxy silane, octadecyl dimethyl chloro silane, octadecyl methyl dichloro silane, octadecyl methoxy dichloro silane, 7-octenyl dimethyl chloro silane, 7-octenyl trichloro silane, 7-octenyl trimethoxy silane, octylmethyl dichloro silane, octyldimethyl chloro silane, octyl trichloro silane, 10-undecenyl dimethyl chloro silane, undecyl trichloro silane, vinyldimethyl chloro silane, methyl octadecyl dimethoxy silane, methyl dodecyl diethoxy silane, methyl octadecyl silane, methyl octadecyl diethoxy silane, n-octyl methyl dimethoxy silane, n-octyl methyl diethoxy silane, triacontyl dimethyl chloro silane, triacontyl trichloro silane, methyl trimethoxy silane, methyl triethoxy silane, methyl tri-n-propoxy silane, methyl isopropoxy silane, methyl-n-butyloxy silane, methyl tri-sec-butyloxy silane, methyl tri-t-butyloxy silane, ethyl trimethoxy silane, ethyl triethoxy silane, ethyl tri-n-propoxy silane, ethyl isopropoxy silane, ethyl-n-butyloxy silane, ethyl tri-sec-butyloxy silane, ethyl tri-t-butyloxy silane, n-propyl trimethoxy silane, isobutyl trimethoxy silane, n-hexyl trimethoxy silane, hexadecyl trimethoxy silane, n-octyl trimethoxy silane, n-dodecyl trimethoxy silane, n-octadecyl trimethoxy silane, n-propyl triethoxy silane, isobutyl triethoxy silane, n-hexyl triethoxy silane, hexadecyl triethoxy silane, n-octyl triethoxy silane, n-dodecyl trimethoxy silane, n-octadecyl triethoxy silane, 2-[2-(trichlorosilyl)ethyl]pyridine, 4-[2-(trichlorosilyl)ethyl]pyridine, diphenyl dimethoxy silane, diphenyl diethoxy silane, 1,3(trichlorosilyl methyl)heptacosane, dibenzyl dimethoxy silane, dibenzyl diethoxy silane, phenyl trimethoxy silane, phenyl methyl dimethoxy silane, phenyl dimethyl methoxy silane, phenyl dimethoxy silane, phenyl diethoxy silane, phenyl methyl diethoxy silane, phenyl dimethyl ethoxy silane, benzyl triethoxy silane, benzyl trimethoxy silane, benzyl methyl dimethoxy silane, benzyl dimethyl methoxy silane, benzyl dimethoxy silane, benzyl diethoxy silane, benzyl methyl diethoxy silane, benzyl dimethyl ethoxy silane, benzyl triethoxy silane, dibenzyl dimethoxy silane, dibenzyl ethoxy silane, 3-acetoxy propyl trimethoxy silane, 3-acryloxy propyl trimethoxy silane, allyl trimethoxy silane, allyl triethoxy silane, 4-aminobutyl triethoxy silane, (aminoethyl aminomethyl)phenethyl trimethoxy silane, N-(2-aminoethyl)-3-aminopropyl methyl dimethoxy silane, N-(2-aminoethyl)-3-aminopropyl trimethoxy silane, 6-(aminohexyl aminopropyl)trimethoxy silane, p-aminophenyl trimethoxy silane, p-aminophenyl ethoxy silane, m-aminophenyl trimethoxy silane, m-aminophenyl ethoxy silane, 3-aminopropyl trimethoxy silane, 3-aminopropyl triethoxy silane, ω-amino undecyl trimethoxy silane, amyl triethoxy silane, benzoxa silepin dimethyl ester, 5-(bicycle heptenyl)triethoxy silane, bis(2-hydroxy ethyl)-3-aminopropyl triethoxy silane, 8-bromooctyl trimethoxy silane, bromophenyl trimethoxy silane, 3-bromopropyl trimethoxy silane, n-butyl trimethoxy silane, 2-chloromethyl triethoxy silane, chloromethyl methyl diethoxy silane, chloromethyl methyl diisopropoxy silane, p-(chloromethyl)phenyl trimethoxy silane, chloromethyl triethoxy silane, chlorophenyl triethoxy silane, 3-chloropropyl methyl dimethoxy silane, 3-chloropropyl triethoxy silane, 3-chloropropyl trimethoxy silane, 2-(4-chlorosulfonyl phenyl)ethyl trimethoxy silane, 2-cyanoethyl triethoxy silane, 2-cyanoethyl trimethoxy silane, cyanomethyl phenethyl trimethoxy silane, 3-cyanopropyl triethoxy silane, 2-(3-cyclohexenyl)ethyl trimethoxy silane, 2-(3-cyclohexenyl)ethyl triethoxy silane, 3-cyclohexenyl trichloro silane, 2-(3-cyclohexenyl)ethyl trichloro silane, 2-(3-cyclohexenyl)ethyl chloro dimethyl silane, 2-(3-cyclohexenyl)ethyl methyl dichloro silane, cyclohexyl dimethyl chloro silane, cyclohexyl ethyl dimethoxy silane, cyclohexyl methyl dichloro silane, cyclohexyl methyl dimethoxy silane, (cyclohexyl methyl)trichloro silane, cyclohexyl trichloro silane, cyclohexyl trimethoxy silane, cyclooctyl trichloro silane, (4-cyclooctenyl)trichloro silane, cyclopentyl trichloro silane, cyclopentyl trimethoxy silane, 1,1-diethoxy-1-silacyclo pentadiene-3-ene, 3-(2,4-dinitro phenyl)propyl triethoxy silane, (dimethyl chlorosilyl)methyl-7,7-dimethyl norpinane, (cyclohexyl aminomethyl)methyl diethoxy silane, (3-cyclopenta dienylpropyl)triethoxy silane, N,N-diethyl-3-aminopropyl trimethoxy silane, 2-(3,4-epoxy cyclohexyl)ethyl trimethoxy silane, 2-(3,4-epoxy cyclohexyl)ethyl triethoxy silane, (furfuryloxy methyl)triethoxy silane, 2-hydroxy-4-(3-triethoxy propoxy)diphenyl ketone, 3-(p-methoxy phenyl)propyl methyl dichloro silane, 3-(p-methoxy phenyl)propyl trichloro silane, p-(methyl phenethyl)methyl dichloro silane, p-(methyl phenethyl)trichloro silane, p-(methyl phenethyl)dimethyl chloro silane, 3 morpholinopropyl trimethoxy silane, (3-glycidoxy propyl)methyl diethoxy silane, 3-glycidoxy propyl trimethoxy silane, 1,2,3,4,7,7-hexachloro-6-methyl diethoxy silyl-2-norbornene, 1,2,3,4,7,7-hexachloro-6-triethoxy silyl-2-norbornene, 3-iodopropyl trimethoxy silane, 3-isocyanato propyl triethoxy silane, (mercapto methyl)methyl diethoxy silane, 3-mercapto propyl methyl dimethoxy silane, 3-mercapto propyl dimethoxy silane, 3-mercapto propyl triethoxy silane, 3-methacryloxy propyl methyldiethoxy silane, 3-methacryloxy propyl trimethoxy silane, methyl{2-(3-trimethoxy silyl propylamino)ethylamino}-3-propionate, 7-octenyloxy trimethoxy silane, R—N-α-phenethyl-N′-triethoxy silyl propyl urea, S—N-α-phenethyl-N′-triethoxy silyl propyl urea, phenethyl trimethoxy silane, phenethyl methyl dimethoxy silane, phenethyl dimethyl methoxy silane, phenethyl dimethoxy silane, phenethyl diethoxy silane, phenethyl methyl diethoxy silane, phenethyl dimethyl ethoxy silane, phenethyl triethoxy silane, (3-phenylpropyl)dimethyl chloro silane, (3-phenylpropyl)methyl dichloro silane, N-phenyl aminopropyl trimethoxy silane, N-(triethoxy silyl propyl)dansylamide, N-(3-triethoxy silyl propyl)-4,5-dihydroimidazole, 2-(triethoxy silyl ethyl)-5-(chloro acetoxy) bicycloheptane, (S)—N-triethoxy silyl propyl-O-mentho carbamate, 3-(triethoxy silyl propyl)-p-nitrobenzamide, 3-(triethoxy silyl)propyl succinic anhydride, N-[5-(trimethoxy silyl)-2-aza-1-oxo-pentyl]caprolactam, 2-(trimethoxy silyl ethyl)pyridine, N-(trimethoxy silyl ethyl)benzyl-N,N,N-trimethyl ammonium chloride, phenyl vinyl diethoxy silane, 3-thiocyanate propyl triethoxy silane, (tridecafluoro 1,1,2,2-tetrahydrooctyl)triethoxy silane, N-{3-(triethoxy silyl) propyl}phthalamide acid, (3,3,3-trifluoropropyl)methyl dimethoxy silane, (3,3,3-trifluoropropyl)trimethoxy silane, 1-trimethoxy silyl-2-(chloromethyl)phenyl ethane, 2-(trimethoxy silyl)ethyl phenyl sulfonyl azide, β-trimethoxy silyl ethyl-2-pyridine, trimethoxy silyl propyl diethylene triamine, N-(3-trimethoxy silyl propyl)pyrrole, N-trimethoxy silyl propyl-N,N,N-tributyl ammonium bromide, N-trimethoxy silyl propyl-N,N,N-tributyl ammonium chloride, N-trimethoxy silyl propyl-N,N,N-trimethyl ammonium chloride, vinyl methyl diethoxy silane, vinyl triethoxy silane, vinyl trimethoxy silane, vinyl methyl dimethoxy silane, vinyl dimethyl methoxy silane, vinyl dimethyl ethoxy silane, vinyl methyl dichloro silane, vinyl phenyl dichloro silane, vinyl phenyl diethoxy silane, vinyl phenyl dimethyl silane, vinyl phenyl methyl chloro silane, vinyl triphenoxy silane, vinyl tris-t-butoxy silane, adamantylethyl trichloro silane, allyl phenyl trichloro silane, (aminoethyl aminomethyl)phenethyl trimethoxy silane, 3-aminophenoxy dimethyl vinyl silane, phenyl trichloro silane, phenyl dimethyl chloro silane, phenyl methyl dichloro silane, benzyl trichloro silane, benzyl dimethyl chloro silane, benzyl methyl dichloro silane, phenethyl diisopropyl chloro silane, phenethyl trichloro silane, phenethyl dimethyl chloro silane, phenethyl methyl dichloro silane, 5-(bicycloheptenyl)trichloro silane, 5-(bicycloheptenyl)triethoxy silane, 2-(bicycloheptyl)dimethyl chloro silane, 2-(bicycloheptyl)trichloro silane, 1,4-bis(trimethoxy silyl ethyl)benzene, bromophenyl trichloro silane, 3-phenoxypropyl dimethyl chloro silane, 3-phenoxypropyl trichloro silane, t-butyl phenyl chloro silane, t-butyl phenyl methoxy silane, t-butyl phenyl dichloro silane, p-(t-butyl)phenethyl dimethyl chloro silane, p-(t-butyl)phenethyl trichloro silane, 1,3-(chlorodimethyl silyl methyl)heptacosane, ((chloromethyl)phenyl ethyl)dimethyl chloro silane, ((chloromethyl)phenyl ethyl)methyl dichloro silane, ((chloromethyl)phenylethyl)trichloro silane, ((chloromethyl)phenylethyl)trimethoxy silane, chlorophenyl trichloro silane, 2-cyanoethyl trichloro silane, 2-cyanoethyl methyl dichloro silane, 3-cyanopropyl methyl diethoxy silane, 3-cyanopropyl methyl dichloro silane, 3-cyanopropyl methyl dichloro silane, 3-cyanopropyl dimethyl ethoxy silane, 3-cyanopropyl methyl dichloro silane, 3-cyanopropyl trichloro silane, fluorinated alkyl silane, and the like and it is possible to use one type or a combination of two or more types which are selected from these.

In addition, as the surfactant, it is possible to use, for example, polyester-modified silicone, polyether-modified silicone, and the like as silicone-based surfactants. As specific examples of the surfactant, there are the examples of, for example, BYK-347, BYK-348, BYK-UV3500, 3510, 3530, 3570 (all product names manufactured by BYK-Chemie GmbH), Surfynol (product name manufactured by Air Products and Chemicals, Inc.), and the like.

Among these, it is preferable that the first modification processing be performed using one type or two or more types which are selected from irradiating ultraviolet rays, applying a silane coupling agent, and applying a surfactant. Due to this, it is possible to improve the penetration of the binding liquid 12 to the inner section of the layer 1 and it is possible for the three dimensional mold object 10 which is obtained as a final product to have particularly high mechanical strength and durability.

In particular, the effect where it is possible to simplify the configuration of the apparatus is obtained in a case where the first modification processing is performed by irradiating ultraviolet rays.

In addition, in a case where the first modification processing is performed by applying a silane coupling agent, it is possible for the three dimensional mold object 10 which is obtained as a final product to have particularly high mechanical strength and durability even in a case where the layer 1 is an inorganic material.

In addition, in a case where the first modification processing is performed by applying a surfactant, it is possible for the binding liquid 12 to even more appropriately penetrate to the inner section of the layer 1 by an optimal surfactant being selected according to the components of the binding liquid 12 and it is possible for the three dimensional mold object 10 which is obtained as a final product to have even higher mechanical strength and durability.

In a case where the first modification processing is performed by irradiating ultraviolet rays, it is preferable that the ultraviolet rays are from an excimer lamp. In an excimer lamp, it is possible for ultraviolet rays with shorter wavelengths (for example, ultraviolet rays with a peak wavelength of 172 nm) to be used, it is possible to more efficiently perform modifying over a shorter period of time, it is possible for the three dimensional mold object 10 to have particularly superior productivity, it is possible to more reliably prevent excessive wetting, repelling, or the like of the binding liquid 12 with respect to the layer 1 and to more reliable form the bonded section 13 with a desired pattern, it is possible for the binding liquid 12 to more appropriately penetrate to the inner section of the layer 1, and it is possible for the three dimensional mold object 10 which is obtained as a final product to have more reliably superior mechanical strength and durability.

The peak wavelength of the ultraviolet rays which are used in the first modification processing is preferable 1 nm or more and 330 nm or less and is more preferable 12 nm or more and 180 nm or less. Due to this, it is possible to more efficiently perform modifying over a shorter period of time, it is possible for the three dimensional mold object 10 to have particularly superior productivity, it is possible to more reliably prevent excessive wetting, repelling, or the like of the binding liquid 12 with respect to the layer 1 and to more reliable form the bonded section 13 with a desired pattern, it is possible for the binding liquid 12 to more appropriately penetrate to the inner section (a deep section in the thickness direction) of the layer 1, and it is possible for the three dimensional mold object 10 which is obtained as a final product to have more reliably superior mechanical strength and durability. In addition, since active oxygen is efficiently generated by irradiating of ultraviolet rays with this wavelength being performed in an atmosphere which includes oxygen (O₂), an action is exhibited where the ultraviolet rays which are irradiated directly modify the configuring material of the layer 1, an action is also exhibited where the configuring material of the layer 1 is modified due to the active oxygen which is generated by the ultraviolet rays, it is possible to more efficiently perform modifying over an even shorter period of time due to these effects acting in combination, it is possible for the three dimensional mold object 10 to have particularly superior productivity, it is possible to more reliably prevent excessive wetting, repelling, or the like of the binding liquid 12 with respect to the layer 1 and to more reliable form the bonded section 13 with a desired pattern, it is possible for the binding liquid 12 to more appropriately penetrate to the inner section (a deep section in the thickness direction) of the layer 1, and it is possible for the three dimensional mold object 10 which is obtained as a final product to have more reliably superior mechanical strength and durability. In contrast to this, if the peak wavelength of the ultraviolet rays which are used in the first modification processing is less than the lower limit, there is an increase in the proportion of the ultraviolet rays, which are consumed in breaking up the oxygen or are absorbed by the oxygen, out of the ultraviolet rays which are emitted and efficient modification processing is difficult in a case where the first modification processing is trialed in an atmosphere which includes oxygen. In addition, if the peak wavelength of the ultraviolet rays which are used in the first modification processing exceeds the upper limit, it is not possible to perform modifying of the layer 1.

Here, the first modification processing may be performed with respect to the entirety of the layer 1 or may be selectively performed with respect to a portion of the layer 1 (for example, a region where the bonded section 13 is provided).

In addition, the first modification processing may be performed while scanning whether or not the first modification processing is appropriately performed on the layer 1 (the layer 1 where the binding liquid 12 is not applied). Due to this, it is possible to perform the modification processing (the first modification processing) to a necessarily sufficient extent by performing additional modification processing in a case where, for example, the modification processing which is carried out on the layer 1 is insufficient.

The series of processes described above are repeatedly performed. Due to this, there is a state where the particles 111 are bonded in portions where the binding liquid 12 are applied out of each of the layers 1 and the three dimensional mold object 10, which is a layered body where a plurality of the layers 1 are layered in this state, is obtained (refer to 2D).

In addition, the binding liquid 12, which is applied to the layer 1 in the binding liquid applying processes from the second time onward (refer to 1E), is used to bond together the particles 111 which configure the layer 1, and a portion of the binding liquid 12 which is applied penetrates beneath the layer 1. For this reason, the binding liquid 12 is used to not only bond together the particles 111 in each of the layers 1 but to bond together the particles 111 between the adjacent layers. As a result, the three dimensional mold object 10 which is obtained as a final product has superior overall mechanical strength.

Here, the modifying process (the second modifying process) is not performed with respect to the layer 1 which is performed last in the present embodiment.

### Unbonded Particles Removing Process

Then, the unbonded particles removing process (2E) of removing the particles 111 which are not bonded using the bonding agent 121 (the unbonded particles) out of the particles 111 which configure each of the layers 1 is performed in a post-processing process after the series of process as described above is repeatedly performed. Due to this, the three dimensional mold object 10 is taken out.

As the detail method of this process, there are the examples of, for example, a method of wiping away the unbonded particles using a brush or the like, a method of removing the unbonded particles using suction, a method of blowing a gas such as air, a method of applying a liquid such as water (for example, a method of immersing the layered body which is obtained as above in a liquid, a method of blowing a liquid, or the like), a method of applying vibration using ultrasonic vibration or the like, and the like. In addition, it is possible to perform a combination of any two or more types of methods which are selected from above. In more detail, there are the examples of a method of immersing in a liquid such as water after blowing a gas such as air, a method of applying ultrasonic vibration in a state of being immersed in a liquid such as water, and the like. Among these, it is preferable that a method is adopted where a liquid which includes water is applied with respect to the layered body which is obtained as described above (in particular, a method of immersing in a liquid which includes water).

Here, adhesiveness between the first layer and the second layer is improved due to the modification processing (the second modification processing), but it is possible for the composition 11 other than the bonded section 13 to be easily and reliably removed in this process since the adhesive force is sufficiently weak compared to the bonding force in the bonded section 13.

According to the manufacturing method of the present invention as described above, it is possible to efficiently manufacture the three dimensional mold object with superior dimensional precision and superior mechanical strength and durability. In addition, it is effective from the point of view of reducing costs in manufacturing the three dimensional mold object since the yield of the three dimensional mold object is improved.

### Three Dimensional Mold Object Manufacturing Apparatus

A three dimensional mold object manufacturing apparatus of the present invention will be described first.

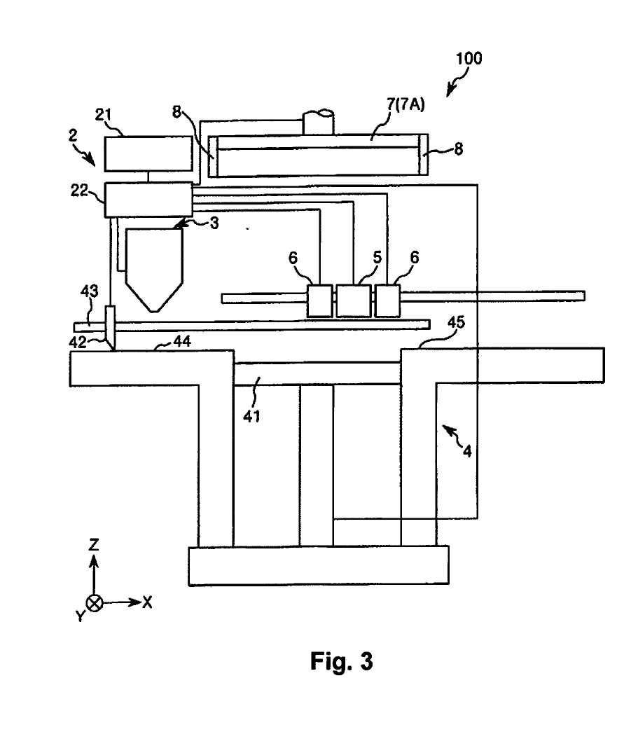

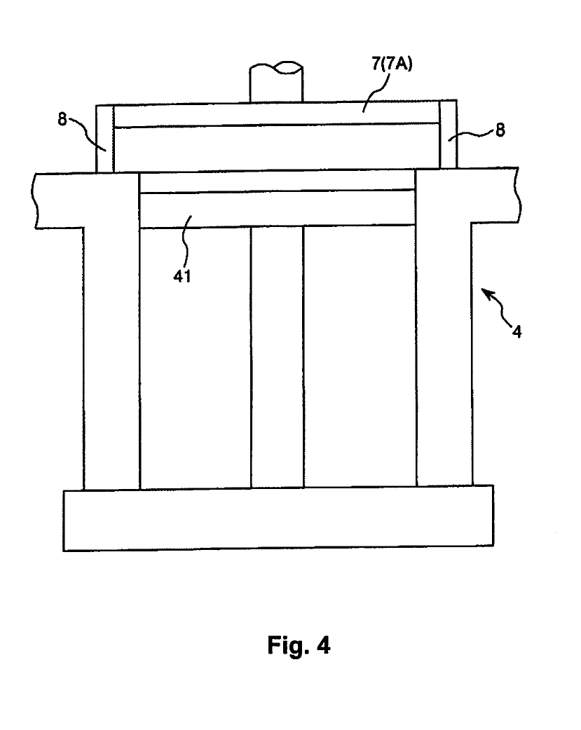

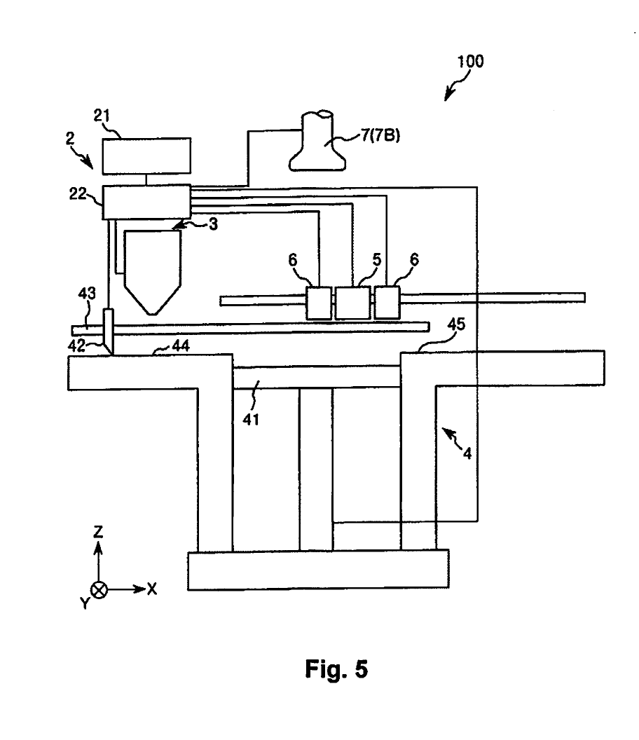

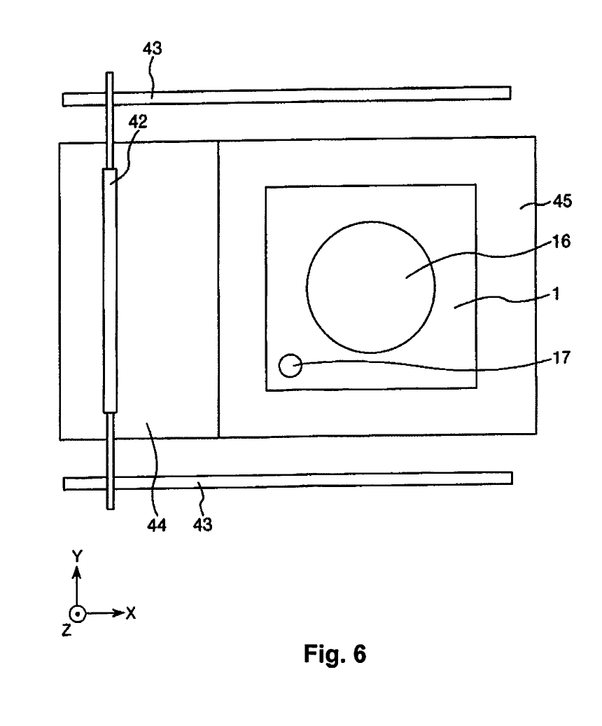

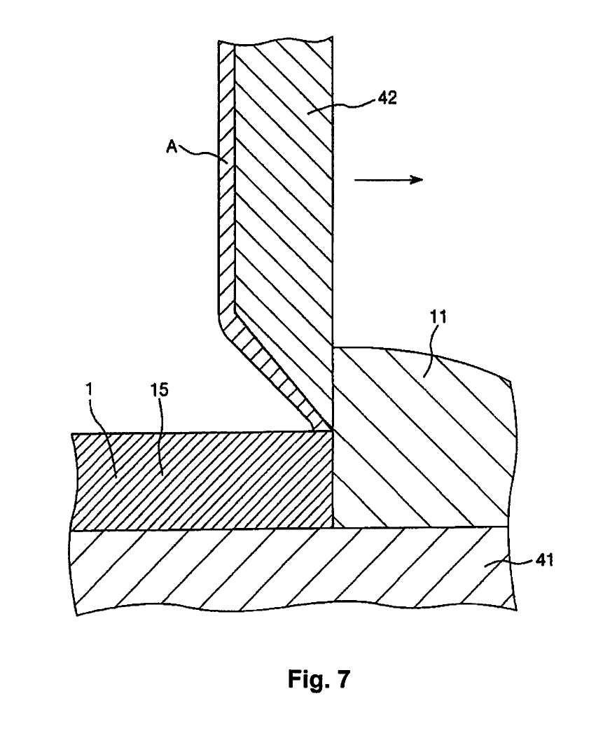

FIG. 3 is a cross sectional diagram schematically illustrating an appropriate embodiment of the three dimensional mold object manufacturing apparatus of the present invention, FIG. 4 is a cross sectional diagram illustrating a state in the three dimensional mold object manufacturing apparatus shown in FIG. 3 where a space where there is the binding liquid discharging section and a space where there is the modifying part are separated, FIG. 5 is a cross sectional diagram schematically illustrating another appropriate embodiment of a three dimensional mold object manufacturing apparatus of the present invention, FIG. 6 is a planar diagram illustrating the relationship between a bonded section forming region, which configures the three dimensional mold object which is the object, and a scanning pattern forming region in a region for forming the layer, and FIG. 7 is a diagram for describing a configuration of the first modifying part of the three dimensional mold object manufacturing apparatus.

A three dimensional mold object manufacturing apparatus 100 manufactures the three dimensional mold object 10 by repeatedly forming and layering the layers 1 using the composition (the particle-containing composition) 11 which includes the particles 111.

As shown in FIG. 3, the three dimensional mold object manufacturing apparatus 100 has a control section 2, a composition supplying section 3 which contains the composition 11 which includes the particles 111, a layer forming section 4 which forms the layers 1 using the composition 11 which is supplied from the composition supplying section 3, a binding liquid discharging section (a binding liquid applying part) 5 which discharges the binding liquid 12 onto the layer 1, an energy ray irradiating part (a curing part) 6 which irradiates energy rays for curing the binding liquid 12, a modifying part 7 which carries out the modification processing (the second modification processing) with respect to the layer 1 where the bonded section 13 is formed, and a scanning part (an impact diameter measuring part) (which is not shown in the diagrams) which checks whether or not the modification processing is appropriately performed on the layer 1 (in the same manner as the three dimensional mold object manufacturing apparatus 100 shown in FIG. 5).

The control section 2 has a computer 21 and a drive control section 22.

The computer 21 is a typical desktop computer or the like which is configured by a CPU, a memory, or the like being internally provided. The computer 21 creates data which is model data of the shape of the three dimensional mold object 10 and outputs cross sectional data, which is obtained by slicing the model data into numerous thin cross sectional bodies which are parallel to each other (slice data), with respect to the drive control section 22.

The drive control section 22 functions as a control means which drives the layer forming section 4, the binding liquid discharging section 5, the energy ray irradiating part 6, the modifying part 7, and the like. In detail, for example, the discharge pattern and the discharge amount of the binding liquid 12 from the binding liquid discharging section 5, the amount of the composition 11 supplied from the composition supplying section 3, the amount by which the raising and lowering state 41 is lowered, the conditions of the modification processing using the modifying part 7, and the like are controlled.

The composition supplying section 3 is configured so as to move due to commands from the drive control section 22 and supply the composition 11 which is contained inside of the composition supplying section 3 to a composition temporary retaining section 44.

The layer forming section 4 has the composition temporary retaining section 44 which temporarily holds the composition 11 which is supplied from the composition supplying section 3, a squeegee (a planarizing part) 42 which forms the layer 1 while planarizing the composition 11 which is held by the composition temporary retaining section 44, a guide rail 43 which regulates the actions of the squeegee 42, a raising and lower stage (the stage) 41 which supports the layer 1 which is formed, and a frame body 45 which is provided so as to surround the raising and lowering stage 41 and to tightly fit with the raising and lowering stage 41.

The raising and lowering stage 41 is sequentially lowered by a predetermined amount due to commands from the drive control section 22 when forming the layer 1 which is new on the layer 1 which is already formed. The thickness of the layer 1 which is newly formed is established due to the amount by which the raising and lowering stage 41 is lowered.

The stage 41 planarizes the surface (the portion where the composition 11 is applied). Due to this, it is possible to easily and reliably form the layer 1 with highly uniform thickness.

It is preferable that the stage 41 be configured of a material with high strength. As the configuring material of the stage 41, there are the examples of, for example, various types of metallic materials such as stainless steel.

In addition, surface processing may be carried out on the surface of the stage 41 (the portion where the composition 11 is applied). Due to this, it is possible to, for example, effectively prevent the configuring materials of the composition 11 and the configuring materials of the binding liquid 12 from becoming attached to the stage 41, have particularly superior durability of the stage 41, and achieve stable productivity of the three dimensional mold object 10 over a longer period of time. As the material which is used in the surface processing on the surface of the stage 41, there are the examples of, for example, a fluorine resin such as polytetrafluoroethylene.

The squeegee 42 has a longitudinal shape which extends in the X direction and is provided with a blade which has a shape with an edge where a front tip of a lower portion is sharp.

A vibration mechanism (which is not shown in the diagrams) which applies slight vibrations to the blade may be provided so that the length of the blade in the Y direction smoothly performs spreading of the composition 11 using the squeegee 42.

The binding liquid discharging section (the binding liquid applying part) 5 discharges the binding liquid 12 onto the layer 1 using an ink jet system. Due to the binding liquid discharging section (the binding liquid applying part) 5 being provided, it is possible to apply the binding liquid 12 with a fine pattern and particularly productively manufacturing is possible even the three dimensional mold object 10 which has a fine structure.

As the liquid droplet discharging method (the method of the ink jet system), it is possible to use a piezoelectric method, a method where the binding liquid 12 is discharged using foam (bubbles) which are generated by heating the binding liquid 12, and the like, but the piezoelectric method is preferable from the point of view of difficulties with changing the properties of the configuring components of the binding liquid 12 and the like.

The binding liquid discharging section (the binding liquid applying part) 5 controls the amount of the binding liquid 12 which is applied to each section of the layer 1 as the pattern which is to be formed on each of the layers 1 due to commands from the drive control section 22. The discharge pattern, the discharge amount, and the like of the binding liquid 12 from the binding liquid discharging section (the binding liquid applying part) 5 is determined based on the slice data. Due to this, it is possible to apply the binding liquid 12 in an amount which is necessarily sufficient to the target portions, it is possible to reliably form the bonded section 13 in the desired pattern, and it is possible for the three dimensional mold object 10 to have more reliably superior dimensional precision and mechanical strength. In addition, it is possible to reliably obtain the desired color tone, design, and the like in a case where the binding liquid 12 includes a coloring agent.

The energy ray irradiating part (the curing part) 6 irradiates energy rays for curing the binding liquid 12 which is applied to the layer 1. That is, in the configuration shown in the diagrams, the bonded section forming part is provided with the curing part 6, which cures a curable component which is included in the binding liquid, in addition to the binding liquid applying part 5.

In this manner, due to the curing part 6 being provided, it is possible for the bonding strength of the particles 111 in the bonded section 13 and the mechanical strength of the bonded section 13 (the three dimensional mold object 10) to be particularly superior. In addition, it is easy for problems to be generated such as deteriorating of adhesiveness of the powder layer, which is formed direct on the powder layer (the layer) which has the bonded section, in the prior art in a case where the bonded section includes curable material with the curable component, but it is possible to reliably prevent the problems described above from being generated in the present invention even in a case where the bonded section includes the curable material with the curable component. That is, the effects due to the present invention are more remarkably exhibited in a case where the bonded section forming part is provided with the curing part, which cures the curable component which is included in the binding liquid, in addition to the binding liquid applying part.

The type of energy rays which are irradiated from the energy ray irradiating part (the curing part) 6 differs according to the configuring material of the binding liquid 12, and there are the examples of, for example, ultraviolet rays, visible light rays, infrared rays, X rays, γ rays, electron rays, ion beams, and the like. Among these, it is preferable that ultraviolet rays are used from the point of view of cost and productivity of the three dimensional mold object.

In a case where the energy ray irradiating part 6 (is an ultraviolet ray irradiating part which) irradiates ultraviolet rays, the peak wavelength of the ultraviolet rays is preferable 340 nm or more and 400 nm or less and is more preferable 350 nm or more and 380 nm or less. Due to this, it is possible to more reliably cure the binding liquid 12 which penetrates to the inner section (a deep section) of the layer 1 due to the ultraviolet rays reaching to the inner section (the deep section) even in a case where the thickness of the layer 1 is relatively large. In contrast to this, if the peak wavelength of the ultraviolet rays which are irradiated from the energy ray irradiating part (the curing part) 6 is less than the lower limit, it is difficult for the ultraviolet rays to reach to the inner section (the deep section) in a case where the thickness of the layer 1 is relatively large and it is difficult to reliably cure the binding liquid 12 which penetrates to the inner section of the layer 1. As a result, there is a possibility that the mechanical strength, reliability, and the like of the three dimensional mold object 10 which is obtained as a final product is reduced. In addition, if the peak wavelength of the ultraviolet rays which are irradiated from the energy ray irradiating part (the curing part) 6 exceeds the upper limit, light energy is reduced and it is difficult to reliably cure the binding liquid 12.

The modifying part 7 carries out the modification processing with respect to the layer 1 (the first layer) where the bonded section 13 is formed.

In the configuration in FIG. 3 and FIG. 4, the modifying part 7 (7A) is an ultraviolet ray irradiating part which irradiates ultraviolet rays. Due to this configuration, it is possible to stably manufacture the three dimensional mold object 10 over a long period of time without performing supplementing of materials for the modification processing. In addition, it is possible to omit or simplify preparation for the modification processing and processing after the modification processing and it is possible for the three dimensional mold object 10 to have particularly superior productivity.

In the configuration in FIG. 3 and FIG. 4, the area of an irradiating region using an irradiating section of the ultraviolet ray irradiating part which is the modifying part 7 (7A) is larger than the area of the layer 1 (the area of the stage 41). Due to this, it is possible to effectively prevent unintentional variation from being generated in the extent of the modifying at each portion of the layer 1.

As the energy rays which are irradiated from the modifying part 7A, there are the examples of, for example, ultraviolet rays, visible light rays, infrared rays, X rays, γ rays, electron rays, ion beams, and the like.

In particular, it is particularly effective from the point of view of cost and productivity of the three dimensional mold object 10 that the modifying part 7A is an ultraviolet ray irradiating part which irradiates ultraviolet rays.

It is preferable that the modifying part 7A be an excimer lamp. In an excimer lamp, it is possible for ultraviolet rays with shorter wavelengths (for example, ultraviolet rays with a peak wavelength of 172 nm) to be used, it is possible to more efficiently perform modifying over a shorter period of time, it is possible for the three dimensional mold object 10 to have particularly superior productivity, and it is possible for the three dimensional mold object 10 to have particularly superior dimensional precision, mechanical strength, durability, and the like.

The peak wavelength of the ultraviolet rays which are irradiated from the modifying part 7A is preferable 1 nm or more and 330 nm or less and is more preferable 12 nm or more and 180 nm or less. Due to this, it is possible to more efficiently perform modifying over a shorter period of time, it is possible for the three dimensional mold object 10 to have particularly superior productivity, and it is possible for the three dimensional mold object 10 to have particularly superior dimensional precision, mechanical strength, durability, and the like. In addition, since active oxygen is efficiently generated by irradiating of ultraviolet rays with this wavelength being performed in an atmosphere which includes oxygen (O₂), an action is exhibited where the ultraviolet rays which are irradiated directly modify the configuring material of the layer 1, an action is also exhibited where the configuring material of the layer 1 is modified due to the active oxygen which is generated by the ultraviolet rays, it is possible to more efficiently perform modifying over an even shorter period of time due to these effects acting in combination, it is possible for the three dimensional mold object 10 to have more superior productivity, and it is possible for the three dimensional mold object 10 to have particularly superior dimensional precision, mechanical strength, durability, and the like. In contrast to this, if the peak wavelength of the ultraviolet rays which are irradiated from the modifying part 7A is less than the lower limit, there is an increase in the proportion of the ultraviolet rays, which are consumed in breaking up the oxygen or are absorbed by the oxygen, out of the ultraviolet rays which are emitted and efficient modification processing is difficult in a case where the modification processing (the second modification processing) is trialed in an atmosphere which includes oxygen. In addition, if the peak wavelength of the ultraviolet rays which are irradiated from the modifying part 7A exceeds the upper limit, it is not possible to perform modifying of the layer 1.

In the configuration shown in FIG. 5, the modifying part 7 (7B) is a modifying agent applying part which applies a modifying agent. Due to this configuration, it is possible to more appropriately perform processing according to the formation of the layer 1 where the modification processing is carried out (the layer 1 where the bonded section 13 is formed) by selecting the type of modifying agent and the like.

In particular, in the configuration shown in FIG. 5, the modifying part 7 (7B) sprays a composition in liquid form which includes a modifying agent using a spraying system. Due to this configuration, it is possible to easily control the amount of the modifying agent which is applied with respect to the layer 1 and it is possible to effectively prevent unintentional variation being generated in the amount of the modifying agent which is applied to each portion of the layer 1. In addition, compared to a case of performing with a gas phase system, it is possible to omit or simplify an operation for replacing the atmosphere when performing following processes and it is effective from the point of view of improving the productivity of the three dimensional mold object 10 since it is possible to prevent excess modifying agent in the atmosphere after the modification processing. In addition, it is possible to simplify the process for drying after the modification processing compared to a case where another liquid phase system is adopted.

The modification processing using the modifying part 7 may be performed with respect to the entirety of the layer 1 or may be selectively performed with respect to a predetermined portion of the layer 1 (for example, a region where the bonded section 13 is provided or the like).

There is a configuration in the three dimensional mold object manufacturing apparatus 100 shown in FIG. 3 and FIG. 4 where the binding liquid discharging section (the binding liquid applying part) 5 and the layer 1 which receives the modification processing move relatively when performing the modification processing using the modifying part 7 and there is a state where there is a space which separates the binding liquid discharging section (the binding liquid applying part) 5 and the layer 1 which receives the modification processing (a state where the binding liquid discharging section (the binding liquid applying part) 5 is not influenced by the modifying part 7).

In more detail, in the three dimensional mold object manufacturing apparatus 100 shown in FIG. 3 and FIG. 4, the binding liquid discharging section (the binding liquid applying part) 5 is moved to a different region on the stage 41 when performing the modification processing using the modifying part 7 and the modifying part 7A is moved downward along with a wall section 8 which is disposed so as to surround the irradiating section of the modifying part 7A. Due to this, the layer 1 which is formed on the stage 41 is enclosed within a closed space which is surrounded by the modifying part 7, the stage 41, and the wall section (a partition wall) 8 and there is a space which separates the modifying part 7 and the binding liquid discharging section (the binding liquid applying part) 5. In this state (a state where the binding liquid discharging section 5 is not influenced by the modifying part 7), the modification processing using the modifying part 7 is performed.

Due to this, it is possible to more effectively prevent change of the properties of the binding liquid 12 which is in the vicinity of the nozzle of the binding liquid discharging section 5 due to influences from the modification processing using the modifying part 7 (for example, changing the viscosity of the binding liquid 12, curing of the binding liquid 12, and the like), and it is possible to more stably perform discharging of liquid droplets and manufacturing of the three dimensional mold object 10 over a long period of time.

In addition, with this configuration, it is possible for the efficiency of the modification processing using the modifying part 7 to be particularly superior since the modifying part 7A is closer to the layer 1 when performing the modification processing using the modifying part 7.

The scanning part has a function of checking whether or not the modification processing is appropriately performed on the layer 1.

Due to the scanning part being provided, it is possible to check whether or not the modification processing is appropriately performed on the layer 1 and it is possible perform additional modification processing according to requirements. As a result, it is possible to more productively and more reliably manufacture the three dimensional mold object 10 with superior dimensional precision and superior mechanical strength and durability.

In the present embodiment, the scanning part (is an impact diameter measuring part which) checks the extent of the modification processing which is carried out on the layer 1 by measuring the impact diameter of liquid droplets of the binding liquid 12, which are discharged using the binding liquid discharging section (the binding liquid applying part) 5, on the layer 1. Due to this, it is possible to easily and appropriately check the extent of the modification processing which is carried out on the layer 1.

The modification processing using the modifying part 7 is performed so that the impact diameter of the binding liquid 12 on the layer 1 are a predetermined size in a case where it is determined that the modification processing which is carried out on the layer 1 is insufficient by measuring using the scanning part (the impact diameter measuring part).

The conditions of the modification processing with respect to the same layer 1 from the second time onward are determined based on the result of measuring using the scanning part (the impact diameter measuring part). In detail, the processing conditions of the modification processing with respect to the same layer 1 from the second time onward are determined based on the size of the liquid droplets of the binding liquid 12 which are measured using the scanning part (the impact diameter measuring part).

In addition, the conditions of the first of the modification processing with respect to the layer 1 from the second layer onward (the n+1^{th} layer of the layer 1) may be adjusted based on the conditions of the modification processing which is carried out on the layers 1 which are already formed before this (from the first layer to the n^{th} layer of the layer 1) when performing the modification processing using the modifying part 7 with respect to the layer 1 (the n+1^{th} layer of the layer 1). For example, in a case where the modification processing is carried out a plurality of times with respect to the unit of the layer 1 which is already formed before the n+1^{th} layer of the layer 1, the conditions for the first of the modification processing with respect to the n+1^{th} layer of the layer 1 may be harsher than the conditions for the first of the modification processing with respect to the unit of the layer 1 which is already formed before this. In more detail, in a case where the modification processing is carried out a plurality of times with respect to the unit of the layer 1 which is already formed prior to the n+1^{th} layer of the layer 1, ultraviolet rays with the amount of energy, which corresponds to the total amount of energy in the ultraviolet rays which are irradiated over the plurality of time of the modification processing, may be irradiated in the first of the modification processing with respect to the n+1^{th} layer of the layer 1. Due to this, it is possible to achieve a further improvement in productivity of the three dimensional mold object 10.

The scanning using the scanning part (the impact diameter measuring part) may be performed in a region where the bonded section 13, which configures the three dimensional mold object 10 which is the object, is to be formed in the layer 1 and a scanning pattern forming region 17 where a pattern for scanning is provided in the configuration shown in FIG. 6 in a region which is different to a bonded section forming region 16 where the bonded section 13, which configures the three dimensional mold object 10 which is the object, is formed in the layer 1. Due to this, it is possible for the dimensional precision of the three dimensional mold object 10 which is obtained as a final product to be reliably higher since it is not necessary to apply liquid for scanning to a region which corresponds to the three dimensional mold object 10 which is to be manufactured.

In addition, ink for scanning may be used instead of the binding liquid 12 in the scanning using the scanning part (the impact diameter measuring part). In this case, it is possible for the ink for scanning to be discharged from an ink discharging section (an ink applying part) which has a configuration which is the same as the binding liquid discharging section (the binding liquid applying part) 5. In addition, in this case, it is possible to more appropriately perform the scanning using the scanning part (the impact diameter measuring part) by adjusting the formation of the ink and the like.

In addition, the three dimensional mold object manufacturing apparatus 100 may be provided with a modifying part (a first modifying part) for performing the first modification processing which is not shown in FIG. 3 to FIG. 5 may be provided separately to the modifying part (a second modifying part) 7 in a case where the first modification processing is performed as described above with respect to the layer 1 where the binding liquid 12 is not applied.

As the first modifying part, it is possible to use, for example, the modifying part with the same configuration as the modifying part (the second modifying part) 7 described above, but the modifying part with, for example, the configuration shown in FIG. 7 may be used. In the configuration in FIG. 7, there is a configuration where a composition (a modifying agent-containing composition) A which includes a modifying agent is supplied at a predetermined supply speed from a rear surface (a surface on the opposite side to the progression direction of the squeegee 42) side of a blade portion of the squeegee 42. That is, the squeegee (the planarizing part) 42 and the first modifying part are integrally provided in the configuration shown in FIG. 7. Due to this configuration, it is possible to perform forming of the layer 1 and forming of a modified section 15 using the first modification processing so as to progress at the same time. As the configuration for supplying the modifying agent-containing composition A at a predetermined supply speed from the rear surface side of the blade portion of the squeegee 42, there are the examples of, for example, a configuration where the modifying agent-containing composition A which is supplied from a portion above the blade portion is transferred along the rear surface of the blade portion, a configuration where a region on the rear surface side of the blade portion is configured using a material with hole sections (a porous material) and the modifying agent-containing composition A seeps out of the hole sections, and the like.

In addition, the modifying part 7 described above in the three dimensional mold object manufacturing apparatus 100 may perform the first modification processing in addition to the second modification processing.

In addition, in a case where the first modification processing is performed as described above with respect to the layer 1 where the binding liquid 12 is not applied, the scanning part (a first scanning part) (which is not shown in the diagrams) for checking whether or not the first modification processing is appropriately performed is provided in addition to the scanning part (a second scanning part) for checking whether or not the second modification processing is appropriately performed. In this case, it is possible to use the scanning part, which is the same as the scanning part described above, as the first scanning part. In addition, the scanning part described above in the three dimensional mold object manufacturing apparatus 100 may perform scanning for checking whether or not the first modification processing is appropriately performed in addition to scanning for checking whether or not the second modification processing is appropriately performed.

According to the three dimensional mold object manufacturing apparatus of the present invention as described above, it is possible to efficiently manufacture the three dimensional mold object with superior dimensional precision and superior mechanical strength and durability. In addition, it is effective from the point of view of reducing costs in manufacturing the three dimensional mold object since the yield of the three dimensional mold object is improved.

In addition, with the configuration shown in FIG. 7, the modified section 15 is formed over the entirety of the layer 1 in the thickness direction (to the deepest section of the layer 1) by the entirety of the layer 1 in the thickness direction being modified, but the modified section 15 may be formed in only a portion of the layer 1 in the thickness direction.

### Binding Liquid

Next, the binding liquid which is used in manufacturing the three dimensional mold object of the present invention will be described in detail.

The binding liquid 12 includes at least the bonding agent 121.

### Bonding Agent

The bonding agent 121 may be any bonding agent as long as it has the function of bonding the particles 111.

As the bonding agent 121, there are the examples of, for example, thermoplastic resins, thermosetting resins, various types of photocurable resins such as visible light curable resins which are cured using the spectrum of visible light (photocurable resins in a narrow sense), ultraviolet ray curable resins, and infrared curable resins, X-ray curable resins, and the like, and it is possible to use one type or a combination of two or more types which are selected from these. Among these, it is preferable that the bonding agent 121 is a curable resin from the point of view of mechanical strength of the three dimensional mold object 10 which is obtained, productivity of the three dimensional mold object 10, and the like. In addition, among the various types of curable resins, ultraviolet ray curable resins (polymerizable compounds) are particularly preferable from the point of view of mechanical strength of the three dimensional mold object 10 which is obtained, productivity of the three dimensional mold object 10, safe storage of the bonding agent 121, and the like.

As the ultraviolet ray curable resins (polymerizable compounds), it is preferable to use a resin where addition polymerization or ring-opening polymerization is started and a polymer is generated due to a radial type, a cation type, or the like which is generated from a photopolymerization initiator due irradiating of ultraviolet rays. As the addition polymerization format, there are the examples of radial, cation, anion, metathesis, and coordination polymerization. In addition, as the ring-opening polymerization format, there are the examples of cation, anion, radial, metathesis, and coordination polymerization.

As the addition polymerizable compound, there are the examples of, for example, a compound which has at least one ethyleny unsaturated double bond and the like. As the addition polymerizable compound, it is possible to preferably use a compound with at least one or more preferable two or more terminal ethyleny unsaturated bonds.

The polymerizable compound with the ethyleny unsaturated bond has a chemical form of a monofunctional polymerizable compound, a polyfunctional polymerizable compound, or a mixture of these. As the monofunctional polymerizable compound, there are the examples of, for example, unsaturated carboxylic acids (for example, acrylic acids, methacrylic acids, itaconic acids, crotonic acids, isocrotonic acids, maleic acids, and the like) and esters, amides, and the like of the unsaturated carboxylic acids. As the polyfunctional polymerizable compound, an ester of an unsaturated carboxylic acid and an aliphatic polyalcohol compound, an amide of an unsaturated carboxylic acid and an aliphatic polyamine compound, and the like are used.

In addition, it is possible to also use an addition reactant with an ester, amide, isocyanate, or epoxy of unsaturated carboxylic acid which has a nucleophilic substituent such as a hydroxyl group, an amino group, or a mercapto group or a dehydration condensation reactant with the carboxylic acid. In addition, it is possible to also use an addition reactant with an ester, amide, alcohol, amine, or thiol of unsaturated carboxylic acid which has an electrophilic substituent such as an isocyanate group or an epoxy group and a substitution reactant with an ester, amide, alcohol, amine, or thiol of unsaturated carboxylic acid which has a detaching substituent group such as a halogen group or a tosyloxy group.

As specific examples of a radical polymerizable compound which is an ester of an unsaturated carboxylic acid and an aliphatic polyalcohol compound, for example, (meth)acrylate ester is representative and it is possible to use monofunctional and polyfunctional (meth)acrylate esters.

As specific examples of monofunctional (meth)acrylate, there are the examples of, for example, tolyloxy methyl ethyl(meth)acrylate, phenyloxy ethyl(meth)acrylate, cyclohexyl(meth)acrylate, ethyl(meth)acrylate, methyl(meth)acrylate, isobornyl(meth)acrylate, tetrahydro furfuryl(meth)acrylate, and the like.

As specific examples of bifunctional (meth)acrylate, there are the examples of, for example, ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexane diol di(meth)acrylate, tetraethylene glycol di(meth)acrylate, pentaerythritol di(meth)acrylate, dipentaerythritol di(meth)acrylate, and the like.

As specific examples of trifunctional (meth)acrylate, there are the examples of, for example, trimethylolpropane tri(meth)acrylate, trimethylolpropane tri(meth)acrylate, trimethylolpropane alkylene oxide-modified tri(meth)acrylate, pentaerythritol tri(meth)acrylate, dipentaerythritol tri(meth)acrylate, trimethylolpropane tri((meth)acryloyloxy propyl)ether, isocyanurate alkylene oxide-modified tri(meth)acrylate, propionate dipentaerythritol tri(meth)acrylate, tri((meth)acryloyloxyethyl) isocyanurate, hydroxypivalaldehyde-modified dimethylol propane tri(meth)acrylate, sorbitol tri(meth)acrylate, and the like.

As specific examples of tetrafunctional (meth)acrylate, there are the examples of, for example, pentaerythritol tetra(meth)acrylate, sorbitol tetra(meth)acrylate, ditrimethylolpropane tetra(meth)acrylate, propionate dipentaerythritol tetra(meth)acrylate, ethoxylated pentaerythritol tetra(meth)acrylate, and the like.

As specific examples of pentafunctional (meth)acrylate, there are the examples of, for example, sorbitol penta(meth)acrylate, dipentaerythritol penta(meth)acrylate, and the like.

As specific examples of hexafunctional (meth)acrylate, there are the examples of, for example, dipentaerythritol hexa(meth)acrylate, sorbitol hexa(meth)acrylate, phosphazene alkylene oxide-modified hexa(meth)acrylate, caprolactone-modified dipentaerythritol hexa(meth)acrylate, and the like.

As polymerizable compounds other than (meth)acrylate, there are the examples of, for example, itaconic acid esters, crotonic acid esters, isocrotonic acid esters, maleic acid esters, and the like.

As the itaconic acid esters, there are the examples of, for example, ethylene glycol diitaconate, propylene glycol diitaconate, 1,3-butanediol diitaconate, 1,4-butanediol diitaconate, tetramethylene glycol diitaconate, pentaerythritol diitaconate, sorbitol tetraitaconate, and the like.

As the crotonic acid esters, there are the examples of, for example, ethylene glycol dicrotonate, tetramethylene glycol dicrotonate, pentaerythritol dicrotonate, sorbitol tetra dicrotonate, and the like.

As the isocrotonic acid esters, there are the examples of, for example, ethylene glycol isocrotonate, pentaerythritol isocrotonate, sorbitol tetraisocrotonate, and the like.

As the maleic acid esters, there are the examples of, for example, ethylene glycol dimaleate, triethylene glycol dimaleate, pentaerythritol dimaleate, sorbitol tetra malate, and the like.

As examples of other esters, it is possible to, for example, use aliphatic alcohol esters described in Japanese Examined Patent Application Publication No. S46-27926, Japanese Examined Patent Application Publication No. S51-47334, and Japanese Unexamined Patent Application Publication No. S57-196231, esters with an aromatic skeleton described in Japanese Unexamined Patent Application Publication No. S59-5240, Japanese Unexamined Patent Application Publication No. S59-5241, and Japanese Unexamined Patent Application Publication No. H2-226149, esters with an amino group described in Japanese Unexamined Patent Application Publication No. H1-165613, and the like.

As specific examples of a monomer of an amide of an unsaturated carboxylic acid and an aliphatic polyalcohol compound, there are the examples of, for example, methylenebis-acrylamide, methylenebis-methacrylamide, 1,6-hexamethylene bis-acrylamide, 1,6-hexamethylene bis-methacrylamide, diethylenetriamine tris acrylamide, xylylene bisacrylamide, xylylene bismethacrylamide, and the like.

As other preferable amide monomers, there are the examples of, for example, amide monomers with a cyclohexylene structure described in Japanese Examined Patent Application Publication No. S54-21726 and the like.

In addition, a urethane additional polymerization compound which is manufactured using an additional reaction between isocyanate and a hydroxyl group is also appropriate, and as specific examples of this, there are the examples of, for example, vinyl uretange compounds which includes two or more polymerizable vinyl groups in one molecule where a vinyl monomer, which contains a hydroxyl group shown as formula (1) below, is added to a polyisocyanate compound which has two or more isocyanate groups in one molecule which is described in Japanese Examined Patent Application Publication No. S48-41708 and the like.

CH₂═C(R¹)COOCH₂CH(R²)OH (1)

(Here, R¹ and R² in formula (1) each individually represent H or CH3.)

In the present invention, it is possible to appropriately use a cation ring-opening polymerizable compound, which has one or more cyclic ether groups such as an epoxy group or an oxetane group in a molecule, as the ultraviolet ray curable resin (the polymerizable compound).

As the cation polymerization compound, there are the examples of, for example, curable compounds which include a ring-opening polymerizable group and the like, and among these, a curable compound which includes a hetero ring group is particularly preferable. As this curable compound, there are the examples of, for example, epoxy derivatives, oxetane derivatives, tetrahydrofuran derivatives, cyclic lactone derivatives, cyclic carbonate derivatives, cyclic imino ethers such as oxazoline derivatives, vinyl ethers, and the like, and among these, epoxy derivatives, oxetane derivatives, and vinyl ethers are preferable.

As examples of preferable epoxy derivatives, there are the examples of, for example, monofunctional glycidyl ethers, multifunctional glycidyl ethers, monofunctional cycloaliphatic epoxies, polyfunctional cycloaliphatic epoxies, and the like.

Specific examples of specific glycidyl ether compounds includes the examples of diglycidyl ethers (for example, ethylene glycol diglycidyl ethers, bisphenol A diglycidyl ethers, and the like), glycidyl ethers with three or more functional groups (for example, trimethylol ethane triglycidyl ethers, trimethylol propane triglycidyl ethers, glycerol triglycidyl ether, triglycidyl tris-hydroxyethyl isocyanurate, and the like), glycidyl ethers with four or more functional groups (for example, sorbitol tetra glycidyl ethers, pentaerythritol tetraglycyl ethers, polyglycidyl ethers of cresol novolac resins, polyglycidyl ethers of phenol novolac resins, and the like), alicyclic epoxy (for example, CELLOXIDE 2021P, CELLOXIDE 2081, EPOLEAD GT-301, and EPOLEAD GT-401 (all manufactured by Daicel Corp.), EHPE (manufactured by Daicel Corp.), polycyclohexyl epoxy methyl ether of phenol novolac resin, oxetanes (for example, OX-SQ and PNOX-1009 (all manufactured by Toagosei Co., Ltd.), and the like.

It is possible to preferably use alicyclic epoxy derivatives as the polymerizable compound. An “alicyclic epoxy group” refers to partial structures where a double bond of a cycloalkane ring such as a cyclopentene group or a cyclohexene group is epoxied using an appropriate oxidizing agent such as hydrogen peroxide or peracid.

As the alicyclic epoxy derivative, polyfunctional cycloaliphatic epoxies, which have two or more of a cyclohexene oxide group or a cyclopentene oxide group in one molecule, are preferable. As specific examples of alicyclic epoxy compounds, there are the examples of, for example, 4-vinyl cyclohexene dioxide, (3,4-epoxy cyclohexyl)methyl 3,4-epoxy cyclohexyl carboxylate, di(3,4-epoxy cyclohexyl)adipate, di(3,4-epoxy cyclohexyl methyl)adipate, bis(2,3-epoxycyclopentyl)ether, di(2,3-epoxy-6-methylcyclo hexylmethyl)adipate, dicyclopentadiene dioxide, and the like.

It is possible to use a glycidyl compound, which has a typical epoxy group which does not have an alicyclic structure in the molecule, individually or together with the alicyclic epoxy derivative described above.

As a typical glycidyl compound, it is possible for there to be the examples of, for example, a glycidyl ether compound, a glycidyl ester compound, and the like, but use together with a glycidyl ether compound is preferable.

As specific examples of the glycidyl ether compound, there are the examples of, for example, aromatic glycidyl ether compounds such as 1,3-bis(2,3-epoxypropyloxy)benzene, a bisphenol A type epoxy resin, a bisphenol F-type epoxy resin, a phenol novolac epoxy resin, a cresol novolac epoxy resin, and a trisphenolmethane epoxy resin, aliphatic glycidyl ether compounds such as 1,4-butanediol glycidyl ether, glycerol triglycidyl ether, propylene glycol diglycidyl ether, and trimethylolpropane triglycidyl ether, and the like. As the glycidyl ether, it is possible for there to be the examples of, for example, a linoleate dimer glycidyl ether and the like.

As the polymerizable compound, it is possible to use a compound which has an oxetanyl group which is a cyclic ether with a four-membered ring (referred to below simply as “oxetanyl group”). The compound which includes an oxetanyl group is a compound with one or more oxetanyl groups in one molecule.

The content ratio of the bonding agent in the binding liquid 12 is preferable 80% or more by mass and is more preferably 85% or more by mass. Due to this, it is possible for the three dimensional mold object 10 which is obtained as a final product to have particularly superior mechanical strength.

### Other Compounds

In addition, the binding liquid 12 may include compounds other than the compounds described above. As the other compounds, there are the examples of, for example, various types of coloring agents such as pigments and dyes, a dispersing agent, a surfactant, a polymerization initiator, a polymerization accelerator, a solvent, a penetration enhancing agent, a wetting agent (a moisturizing agent), a fixing agent, an antimold agent, a preserving agent, an antioxidizing agent, an ultraviolet absorbing agent, a chelating agent, a pH adjusting agent, a thickening agent, a filler, an aggregation inhibitor, a defoamer, and the like.

In particular, due to the binding liquid 12 including a coloring agent, it is possible to obtain the three dimensional mold object 10 which is colored with a color which corresponds to the color of the coloring agent.

In particular, due to a pigment being included as the color agent, it is possible for light proofing of the binding liquid 12 and the three dimensional mold object 10 to be favorable. It is possible for any inorganic pigment or organic pigment to be used as the pigment.

As the inorganic pigment, there are the examples of, for example, types of carbon black (C.I. Pigment Black 7) such as furnace black, lamp black, acetylene black, and channel black, iron oxide, titanium oxide, and the like, and it is possible to use one type or a combination of two or more types which are selected from these.

Among the inorganic pigments, titanium oxide is preferable for a preferable white color.

As the organic pigment, there are the examples of, for example, azo pigments such as an insoluble azo pigment, a condensed azo pigment, an azo lake pigment, and a chelate azo pigment, polycyclic pigments such as a phthalocyanine pigment, a perylene pigment, a perynone pigment, an anthraquinone pigment, a quinacridone pigment, a dioxane pigment, a thioindigo pigments, and a quinophthalone pigment, dye chelates (for example, basic dye chelates, acidic dye chelates, and the like), color lakes (basic dye lakes and acidic dye lakes), nitro pigments, nitroso pigments, aniline black, daylight fluorescent pigments, and the like, and it is possible to use one type or a combination of two or more types which are selected from these.

In further detail, as carbon black which is used as a black pigment, there are the examples of, for example, No. 2300, No. 900, MCF88, No. 33, No. 40, No. 45, No. 52, MA7, MA8, MA100, No. 2200B, and the like (all manufactured by Mitsubishi Chemical Corp.), Raven 5750, Raven 5250, Raven 5000, Raven 3500, Raven 1255, Raven 700, and the like (all manufactured by Carbon Columbia Inc.), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (all manufactured by Cabot Japan K.K.), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, Special Black 4, and the like (all manufactured by Degussa AG), and the like.

As white pigments, there are the examples of, for example, C.I. pigment white 6, 18, 21, and the like.

As yellow pigments, there are the examples of, for example, C.I. pigment yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and the like.

As magenta pigments, there are the examples of, for example, C.I. pigment red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, and C.I. pigment violet 19, 23, 32, 33, 36, 38, 43, 50, and the like.

As cyan pigments, there are the examples of, for example, C.I. pigment blue 1, 2, 3, 15, 15:1, 15:2, 15:3, 15:34, 15:4, 16, 18, 22, 25, 60, 65, 66, and C.I. vat blue 4, 60, and the like.

In addition, as pigments other than the pigments described above, there are the examples of, for example, C.I. pigment green 7, 10, C.I. pigment brown 3, 5, 25, 26, C.I. pigment orange 1, 2, 5, 7, 13, 14, 15, 16, 24, 34, 36, 38, 40, 43, 63, and the like.

In a case where the binding liquid 12 includes a pigment, the average particular diameter of the pigment is preferably 300 nm or less and is more preferably 50 nm or more and 250 nm or less. Due to this, it is possible to have particularly superior discharge stability of the binding liquid 12 and pigment dispersing stability within the binding liquid 12, and it is possible to form images with more superior image quality.

In addition, as dyes, there are the examples of, for example, acid dyes, direct dyes, reactive dyes, basic dyes, and the like, and it is possible to use one type or a combination of two or more types which are selected from these.

As specific examples of dyes, there are the examples of, for example, C.I. acid yellow 17, 23, 42, 44, 79, 142, C.I. acid red 52, 80, 82, 249, 254, 289, C.I. acid blue 9, 45, 249, C.I. acid black 1, 2, 24, 94, C.I. food black 1, 2, C.I. direct yellow 1, 12, 24, 33, 50, 55, 58, 86, 132, 142, 144, 173, C.I. direct red 1, 4, 9, 80, 81, 225, 227, C.I. direct blue 1, 2, 15, 71, 86, 87, 98, 165, 199, 202, C.I. direct black 19, 38, 51, 71, 154, 168, 171, 195, C.I. reactive red 14, 32, 55, 79, 249, C.I. reactive black 3, 4, 35, and the like.

In a case where the binding liquid 12 includes a coloring agent, the content ratio of the coloring agent in the binding liquid 12 is preferably 1% or more by mass and 20% or less by mass. Due to this, particularly superior concealment and color reproduction are obtained.

In particular, in a case where the binding liquid 12 includes titanium oxide as the coloring agent, the content ratio of titanium oxide in the binding liquid 12 is preferably 12% or more by mass and 18% or less by mass and is more preferably 14% or more by mass and 16% or less by mass. Due to this, particularly superior concealment is obtained.

In a case where the binding liquid 12 includes a pigment, more favorable dispersing of the pigment is possible if a dispersing agent is also included. The dispersing agent is not particularly limited and there are the examples of, for example, dispersing agents which are commonly used in preparing pigment dispersion liquids such as polymer dispersing agents. As specific examples of polymer dispersing agents, there are the examples of, for example, dispersing agents with a main component which is one or more type from polyoxyalkylene polyalkylene polyamines, vinyl polymer and copolymers, acrylic polymers and copolymers, polyesters, polyamides, polyimides, polyurethanes, amino polymers, silicon-containing polymers, sulfur-containing polymers, fluorine-containing polymers, and epoxy resins. As a commercially available product of a polymer dispersing agent, there are the examples of, for example, the AJISPER series from Ajinomoto Fine-Techno Co., Inc., the SOLSPERSE series (SOLSPERSE 36000 and the like) from Lubrizol Corp., the DISPERBYK series from BYK-Chemie GmbH, the DISPARLON series from Kusumoto Chemicals, Ltd., and the like.

It is possible for the three dimensional mold object 10 to have more favorable abrasion resistance if the binding liquid 12 includes a surfactant. The surfactant is not particularly limited and it is possible to use, for example, polyester-modified silicone, polyether-modified silicone, and the like as silicone-based surfactants, and among these, polyether-modified polydimethyl siloxane and polyester modified polydimethyl siloxane are preferable. As specific examples of the surfactant, there are the examples of, for example, BYK-347, BYK-348, BYK-UV3500, 3510, 3530, 3570 (all product names manufactured by BYK-Chemie GmbH), and the like.

In addition, the binding liquid 12 may include a solvent. Due to this, it is possible for adjusting of the viscosity of the binding liquid 12 to be appropriately performed and it is possible for discharge stability of the binding liquid 12 using an ink jet system to be particularly superior even when the binding liquid 12 includes components with high viscosity.

As the solvent, there are the examples of, for example, (poly)alkylene glycol monoalkyl ethers such as ethylene glycol monomethyl ether, ethylene glycol monoethyl ether, propylene glycol monomethyl ether, and propylene glycol mono ethyl ether, acetic acid esters such as ethyl acetate, n-propyl acetate, iso-propyl acetate, n-butyl acetate, and iso-butyl acetate, aromatic hydrocarbons such as benzene, toluene, and xylene, ketones such as methyl ethyl ketone, acetone, methyl isobutyl ketone, ethyl-n-butyl ketone, diisopropyl ketone, and acetylacetone, alcohols such as ethanol, propanol, and butanol, and it is possible to use one type or a combination of two or more types which are selected from these.

In addition, the viscosity of the binding liquid 12 is preferably 10 mPa·s or more and 30 mPa·s or less and is more preferably 15 mPa·s or more and 25 mPa·s or less. Due to this, it is possible for the binding liquid 12 to have particularly superior discharge stability using an ink jet system. Here, viscosity in the present specifications is a value which is measured at 25° C. using an E type viscometer (VISCONIC ELD manufactured by Tokyo Keiki Inc.).

In addition, a plurality of types of the binding liquid 12 may be used in manufacturing the three dimensional mold object 10.

For example, the binding liquid 12 which includes a coloring agent (a color ink) and the binding liquid 12 which does not include a coloring agent (a clear ink) may be used. Due to this, for example, the binding liquid 12 which includes a coloring agent may be used as the binding liquid 12 which is applied to a region which affects the color tone in terms of the outer appearance of the three dimensional mold object 10 and the binding liquid 12 which does not include a coloring agent may be used as the binding liquid 12 which is applied to a region which does not affect the color tone in terms of the outer appearance of the three dimensional mold object 10. In addition, a plurality of types of the binding liquid 12 may be used together such that a region (a coating layer), which is formed using the binding liquid 12 which does not include a coloring agent, is provided on the outer surface of a region, which is formed using the binding liquid 12 which includes a coloring agent, in the three dimensional mold object 10 which is obtained as a final product.

In addition, for example, a plurality of types of the binding liquid 12, which include coloring agents with different compositions, may be used. Due to this, it is possible to have a wide color reproduction region which is able to be expressed using combinations of the binding liquids 12.

In a case where a plurality of types of the binding liquids 12 are used, it is preferable that at least the binding liquid 12 with a cyan color, the binding liquid 12 with a magenta color, and the binding liquid 12 with a yellow color be used. Due to this, it is possible to have a wider color reproduction region which is able to be expressed using combinations of the binding liquids 12.

In addition, the following effects are obtained when, for example, the binding liquid 12 with a white color is used together with the binding liquids 12 with other colors. That is, it is possible for the three dimensional mold object 10 which is obtained as a final product to have a first region where the binding liquid 12 with a white color is applied and a region (a second region) where the binding liquids 12 with the colors other than white are applied to overlap with the first region and be provided more to the outer surface side than the first region. Due to this, it is possible for the first region where the binding liquid 12 with a white color is applied to exhibit concealment and it is possible to further increase color intensity of the three dimensional mold object 10.

### Composition (Particle-Containing Composition)

Next, the composition (the particle-containing composition) 11 which is used in manufacturing of the three dimensional mold object of the present invention will be described in detail next.

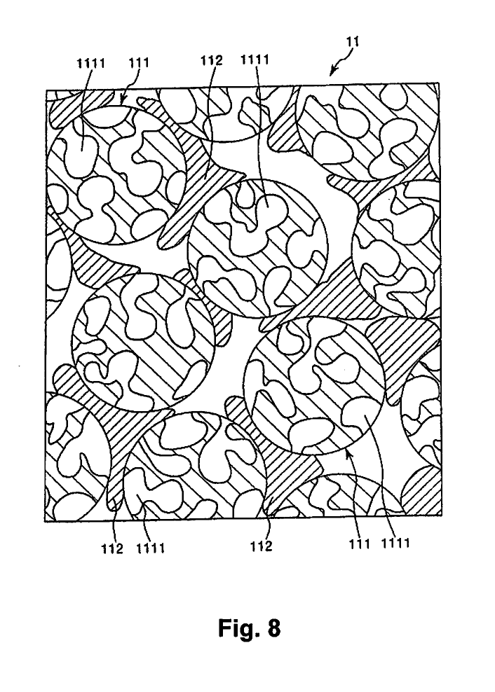

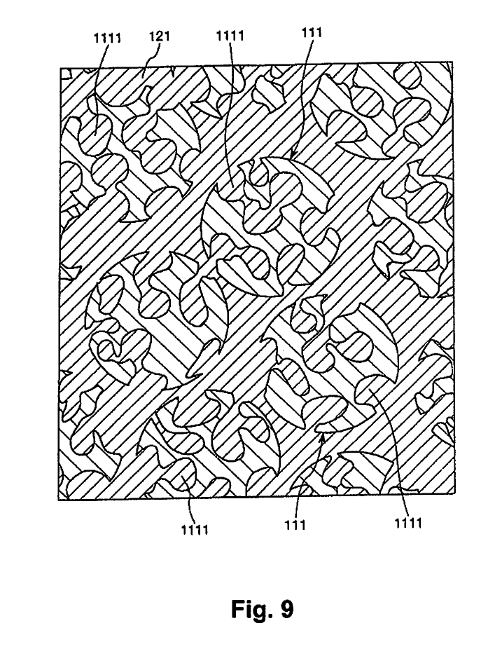

FIG. 8 is a cross sectional diagram schematically illustrating a state in the layer (the particle-containing composition) immediately before a composition applying process. FIG. 9 is a cross sectional diagram schematically illustrating a state where the particles are bonded together using the binding agent which is hydrophobic.

The composition (the particle-containing composition) 11 includes at least a three dimensional molding powder which includes a plurality of the particles 111.

### Three Dimensional Molding Powder (Particles 111)

It is preferable that the particles 111 which configure the three dimensional molding powder be porous and be subject to a hydrophobic processing. Due to this configuration, in a case where the binding liquid 12 includes the bonding agent 121 which is hydrophobic, it is possible for the bonding agent 121 which is hydrophobic to appropriately penetrate inside porous holes 1111 and for an anchor effect to be exhibited when manufacturing the three dimensional mold object 10, and as a result, it is possible to have a superior bonding force in the bonding together of the particles 111 (a bonding force using the bonding agent 121) and it is possible to appropriately manufacture the three dimensional mold object 10 with superior mechanical strength as a result (refer to FIG. 9). In addition, it is possible for the three dimensional molding powder to be appropriately reused. To describe in more detail, since the water soluble resin 112 which will be described later is prevented from entering into the porous holes 1111 if the hydrophobic processing is carried out on the particles 111 which configure the three dimensional mold object, it is possible for the particles 111 in a region where the binding liquid 12 is not applied to be recovered with a high level of purity where the content of impurities is low due to being washed using water or the like in manufacturing of the three dimensional mold object 10. For this reason, it is possible to obtain the particle-containing composition where the desired formation is reliably controlled by again mixing the three dimensional molding powder which is recovered, the water soluble resin 112, and the like in desired proportions. In addition, it is possible to effectively prevent unintentional wet spreading of the binding liquid 12 due to the bonding agent 121 which configures the binding liquid 12 entering into the porous holes 1111 of the particles 111. As a result, it is possible for the three dimensional mold object 10 which is obtained as a final result to have even higher dimensional precision. In addition, in a case where the particles 111 which are porous and are subject to hydrophobic processing are used in a method where modification processing is not carried out with respect to the layer 1 where the bonded section 13 is formed, it is particularly easy for problems to be generated such as deteriorating of adhesiveness of the layer 1 which is formed directly on the layer 1 which has the bonded section 13, but it is possible to reliably prevent the problems described above from being generated in the present invention even in a case where the particles which are porous and are subject to hydrophobic processing are used. That is, the effects of the present invention are more remarkably exhibited in a case where the particles which are porous and are subject to hydrophobic processing are used.

As the configuring material of the particles 111 which configure the three dimensional molding powder, there are the examples of, for example, inorganic material, organic materials, or a composite of these.

As the inorganic materials which configure the particles 111, there are the examples of, for example, various types of metals, metal compounds, and the like. As the metal compounds, there are the examples of, for example, various types of metal oxides such as silica, alumina, titanium oxide, zinc oxide, zirconium oxide, tin oxide, magnesium oxide, and potassium titanate, various types of metal hydroxides such as magnesium hydroxide, aluminum hydroxide, and calcium hydroxide, various types of metal nitride such as silicon nitride, titanium nitride, and aluminum nitride, various types of metal carbides such as silicon carbide and titanium carbide, various types of metal sulfides such as zinc sulfide, various types of metal carbonates such as calcium carbonate and magnesium carbonate, various types of metal sulfates such as calcium sulfate and magnesium sulfate, various types of metal silicates such as calcium silicate and magnesium silicate, various types of metal phosphates such as calcium phosphate, various types of metal borates such as aluminum borate and magnesium borate, a composite of these, or the like.

As the organic materials which configure the particles 111, there are the examples of, for example, synthetic resins, natural polymers, and the like, and in more detail, there are the examples of polyethylene resin, polypropylene, polyethylene oxide, polypropylene oxide, polyethylene imine, polystyrene, polyurethane, polyuria, polyester, silicone resin, acrylic silicone resin, polymers with a (meth)acrylate ester such as polymethyl methacrylate as a configuring monomer, crosspolymers with a (meth)acrylate ester such as a methyl methacrylate cross polymer as a configuring monomer (ethylene acrylate copolymer resin), polyamide resins such as nylon 12, nylon 6, or nylon copolymers, polyimide, carboxymethyl cellulose, gelatin, starch, chitin, chitosan, and the like.

Among these, the particles 111 are preferably configured using inorganic materials, are more preferably configured using a metal oxide, and are even more preferably configured using silica. Due to this, it is possible for the three dimensional mold object 10 to have particularly superior characteristics such as mechanical strength and durability. In addition, in particular, the effects described above are more remarkably exhibited if the particles 111 are configured using silica. In addition, since silica has superior fluidity, it is effective in forming the layers 1 with even higher uniformity in thickness and it is effective in the three dimension mold object 10 having particularly superior productivity and dimensional precision.

It is sufficient if the hydrophobic processing, which is carried out on the particles 111 which configure the three dimensional molding powder, is any process which increases the hydrophobicity of the particles 111, but a process which introduces a hydrocarbon group is preferable. Due to this, it is possible for the hydrophobicity of the particles 111 to be higher. In addition, it is possible for the uniformity of the extent of the hydrophobic processing to be higher for each of the particles 111 and each portion on the surface of the particles 111 (including the surfaces inside of the porous holes 1111) in an easy and reliable manner.

A silane compound which includes a silyl group is preferable as the compound which is used in the hydrophobic processing. As specific examples of the compound which is able to be used in the hydrophobic processing, there are the examples of, for example, hexamethyl disilazane, dimethyl dimethoxy silane, diethyl diethoxy silane, 1-propenyl methyl dichloro silane, propyl dimethyl chloro silane, propyl methyl dichloro silane, propyl trichloro silane, propyl triethoxy silane, propyl trimethoxy silane, styrylethyl trimethoxy silane, tetradecyl trichloro silane, 3-thiocyanate propyl triethoxy silane, p-tolyl dimethyl chloro silane, p-tolyl methyl dichloro silane, p-tolyl trichloro silane, p-tolyl trimethoxy silane, p-tolyl triethoxy silane, di-n-propyl di-n-propoxy silane, diisopropyl diisopropoxy silane, di-n-butyl di-n-propoyl silane, di-sec-butyl di-sec-butyloxy silane, di-t-butyl di-t-butyloxy silane, octadecyl trichloro silane, octadecyl methyl diethoxy silane, octadecyl triethoxy silane, octadecyl trimethoxy silane, octadecyl dimethyl chloro silane, octadecyl methyl dichloro silane, octadecyl methoxy dichloro silane, 7-octenyl dimethyl chloro silane, 7-octenyl trichloro silane, 7-octenyl trimethoxy silane, octylmethyl dichloro silane, octyldimethyl chloro silane, octyl trichloro silane, 10-undecenyl dimethyl chloro silane, undecyl trichloro silane, vinyldimethyl chloro silane, methyl octadecyl dimethoxy silane, methyl dodecyl diethoxy silane, methyl octadecyl silane, methyl octadecyl diethoxy silane, n-octyl methyl dimethoxy silane, n-octyl methyl diethoxy silane, triacontyl dimethyl chloro silane, triacontyl trichloro silane, methyl trimethoxy silane, methyl triethoxy silane, methyl tri-n-propoxy silane, methyl isopropoxy silane, methyl-n-butyloxy silane, methyl tri-sec-butyloxy silane, methyl tri-t-butyloxy silane, ethyl trimethoxy silane, ethyl triethoxy silane, ethyl tri-n-propoxy silane, ethyl isopropoxy silane, ethyl-n-butyloxy silane, ethyl tri-sec-butyloxy silane, ethyl tri-t-butyloxy silane, n-propyl trimethoxy silane, isobutyl trimethoxy silane, n-hexyl trimethoxy silane, hexadecyl trimethoxy silane, n-octyl trimethoxy silane, n-dodecyl trimethoxy silane, n-octadecyl trimethoxy silane, n-propyl triethoxy silane, isobutyl triethoxy silane, n-hexyl triethoxy silane, hexadecyl triethoxy silane, n-octyl triethoxy silane, n-dodecyl trimethoxy silane, n-octadecyl triethoxy silane, 2-[2-(trichlorosilyl)ethyl]pyridine, 4-[2-(trichlorosilyl)ethyl]pyridine, diphenyl dimethoxy silane, diphenyl diethoxy silane, 1,3(trichlorosilyl methyl)heptacosane, dibenzyl dimethoxy silane, dibenzyl diethoxy silane, phenyl trimethoxy silane, phenyl methyl dimethoxy silane, phenyl dimethyl methoxy silane, phenyl dimethoxy silane, phenyl diethoxy silane, phenyl methyl diethoxy silane, phenyl dimethyl ethoxy silane, benzyl triethoxy silane, benzyl trimethoxy silane, benzyl methyl dimethoxy silane, benzyl dimethyl methoxy silane, benzyl dimethoxy silane, benzyl diethoxy silane, benzyl methyl diethoxy silane, benzyl dimethyl ethoxy silane, benzyl triethoxy silane, dibenzyl dimethoxy silane, dibenzyl ethoxy silane, 3-acetoxy propyl trimethoxy silane, 3-acryloxypropyl trimethoxy silane, allyl trimethoxy silane, allyl triethoxy silane, 4-aminobutyl triethoxy silane, (aminoethyl aminomethyl)phenethyl trimethoxy silane, N-(2-aminoethyl)-3-aminopropyl methyl dimethoxy silane, N-(2-aminoethyl)-3-aminopropyl trimethoxy silane, 6-(aminohexyl aminopropyl)trimethoxy silane, p-aminophenyl trimethoxy silane, p-aminophenyl ethoxy silane, m-aminophenyl trimethoxy silane, m-aminophenyl methoxy silane, 3-aminopropyl trimethoxy silane, 3-aminopropyl triethoxy silane, ω-amino undecyl trimethoxy silane, amyl triethoxy silane, benzoxa silepin dimethyl ester, 5-(bicycle heptenyl)triethoxy silane, bis(2-hydroxyethyl)-3-aminopropyl triethoxy silane, 8-bromooctyl trimethoxy silane, bromophenyl trimethoxy silane, 3-bromopropyl trimethoxy silane, n-butyl trimethoxy silane, 2-chloromethyl triethoxy silane, chloromethyl methyl diethoxy silane, chloromethyl methyl diisopropoxy silane, p-(chloromethyl)phenyl trimethoxy silane, chloromethyl triethoxy silane, chlorophenyl triethoxy silane, 3-chloropropyl methyl dimethoxy silane, 3-chloropropyl triethoxy silane, 3-chloropropyl trimethoxy silane, 2-(4-chlorosulfonyl phenyl)ethyl trimethoxy silane, 2-cyanoethyl triethoxy silane, 2-cyanoethyl trimethoxy silane, cyanomethyl phenethyl trimethoxy silane, 3-cyanopropyl triethoxy silane, 2-(3-cyclohexenyl)ethyl trimethoxy silane, 2-(3-cyclohexenyl)ethyl triethoxy silane, 3-cyclohexenyl trichloro silane, 2-(3-cyclohexenyl)ethyl trichloro silane, 2-(3-cyclohexenyl)ethyl chloro dimethyl silane, 2-(3-cyclohexenyl)ethyl methyl dichloro silane, cyclohexyl dimethyl chloro silane, cyclohexylethyl dimethoxy silane, cyclohexyl methyl dichloro silane, cyclohexyl methyl dimethoxy silane, (cyclohexyl methyl)trichloro silane, cyclohexyl trichloro silane, cyclohexyl trimethoxy silane, cyclooctyl trichloro silane, (4-cyclooctenyl)trichloro silane, cyclopentyl trichloro silane, cyclopentyl trimethoxy silane, 1,1-diethoxy-1-silacyclo pentadiene-3-ene, 3-(2,4-dinitro phenyl amino)propyl triethoxy silane, (dimethyl chlorosilyl)methyl-7,7-dimethyl norpinane, (cyclohexyl aminomethyl)methyl diethoxy silane, (3-cyclopenta dienylpropyl)triethoxy silane, N,N-diethyl-3-aminopropyl trimethoxy silane, 2-(3,4-epoxy cyclohexyl)ethyl trimethoxy silane, 2-(3,4-epoxy cyclohexyl)ethyl triethoxy silane, (furfuryloxy methyl)triethoxy silane, 2-hydroxy-4-(3-triethoxy propoxy)diphenyl ketone, 3-(p-methoxy phenyl)propyl methyl dichloro silane, 3-(p-methoxy phenyl)propyl trichloro silane, p-(methyl phenethyl)methyl dichloro silane, p-(methyl phenethyl)trichloro silane, p-(methyl phenethyl)dimethyl chloro silane, 3 morpholinopropyl trimethoxy silane, (3-glycidoxy propyl)methyl diethoxy silane, 3-glycidoxy propyl trimethoxy silane, 1,2,3,4,7,7-hexachloro-6-methyl diethoxy silyl-2-norbornene, 1,2,3,4,7,7-hexachloro-6-triethoxy silyl-2-norbornene, 3-iodopropyl trimethoxy silane, 3-isocyanato propyl triethoxy silane, (mercapto methyl)methyl diethoxy silane, 3-mercapto propyl methyl dimethoxy silane, 3-mercaptopropyl dimethoxy silane, 3-mercapto propyl triethoxy silane, 3-methacryloxy propyl methyl diethoxy silane, 3-methacryloxy propyl trimethoxy silane, methyl{2-(3-trimethoxy silyl propylamino)ethylamino}-3-propionate, 7-octenyloxy trimethoxy silane, R—N-α-phenethyl-N′-triethoxy silyl propyl urea, S—N-α-phenethyl-N′-triethoxy silyl propyl urea, phenethyl trimethoxy silane, phenethyl methyl dimethoxy silane, phenethyl dimethyl silane, phenethyl dimethoxy silane, phenethyl diethoxy silane, phenethyl methyldiethoxy silane, phenethyl dimethyl ethoxy silane, phenethyl trimethoxy silane, (3-phenylpropyl)dimethyl chloro silane, (3-phenylpropyl)methyl dichloro silane, N-phenyl aminopropyl trimethoxy silane, N-(triethoxy silyl propyl)dansylamide, N-(3-triethoxy silyl propyl)-4,5-dihydroimidazole, 2-(triethoxy silyl ethyl)-5-(chloroacetoxy) bicycloheptane, (S)—N-triethoxy silyl propyl-O-mentho carbamate, 3-(triethoxy silyl propyl)-p-nitrobenzamide, 3-(triethoxy silyl)propyl succinic anhydride, N-[5-(trimethoxy silyl)-2-aza-1-oxo-pentyl]caprolactam, 2-(trimethoxy silyl ethyl)pyridine, N-(trimethoxy silyl)benzyl-N,N,N-trimethyl ammonium chloride, phenyl vinyl diethoxy silane, 3-thiocyanate propyl triethoxy silane, (tridecafluoro 1,1,2,2-tetra-hydro-octyl)triethoxy silane, N-{3-(triethoxy silyl)propyl}phthalamide acid, (3,3,3-trifluoropropyl)methyl dimethoxy silane, (3,3,3-trifluoropropyl)trimethoxy silane, 1-trimethoxy silyl-2-(chloromethyl)phenyl ethane, 2-(trimethoxy silyl)ethyl phenyl sulfonyl azide, β-trimethoxy silyl ethyl-2-pyridine, trimethoxy silyl propyl diethylene triamine, N-(3-trimethoxy silyl propyl)pyrrole, N-trimethoxy silyl propyl-N,N,N-tributyl ammonium bromide, N-trimethoxy silyl propyl-N,N,N-tributyl ammonium chloride, N-trimethoxy silyl propyl-N,N,N-trimethyl ammonium chloride, vinyl methyl diethoxy silane, vinyl triethoxy silane, vinyl trimethoxy silane, vinyl methyl dimethoxy silane, vinyl dimethyl methoxy silane, vinyl dimethyl ethoxy silane, vinyl methyl dichloro silane, vinyl phenyl dichloro silane, vinyl phenyl diethoxy silane, vinyl phenyl dimethyl silane, vinyl phenyl methyl chloro silane, vinyl triphenoxy silane, vinyl tris-t-butoxy silane, adamantylethyl trichloro silane, allyl phenyl trichloro silane, (aminoethyl aminomethyl)phenethyl trimethoxy silane, 3-aminophenoxy dimethyl vinyl silane, phenyl trichloro silane, phenyl dimethyl chloro silane, phenyl methyl dichloro silane, benzyl trichloro silane, benzyl dimethyl chloro silane, benzyl methyl dichloro silane, phenethyl diisopropyl chloro silane, phenethyl trichloro silane, phenethyl dimethyl chloro silane, phenethyl methyl dichloro silane, 5-(bicycloheptenyl)trichloro silane, 5-(bicycloheptenyl)triethoxy silane, 2-(bicycloheptyl)dimethyl chloro silane, 2-(bicycloheptyl)trichloro silane, 1,4-bis(trimethoxy silyl ethyl)benzene, bromophenyl trichloro silane, 3-phenoxypropyl dimethyl chloro silane, 3-phenoxypropyl trichloro silane, t-butyl phenyl chloro silane, t-butyl phenyl methoxy silane, t-butyl phenyl dichloro silane, p-(t-butyl)phenethyl dimethyl chloro silane, p-(t-butyl)phenethyl trichloro silane, 1,3-(chlorodimethyl silyl methyl)heptacosane, ((chloromethyl)phenyl ethyl)dimethyl chloro silane, ((chloromethyl)phenyl ethyl)methyl dichloro silane, ((chloromethyl)phenylethyl)trichloro silane, ((chloromethyl)phenylethyl)trimethoxy silane, chlorophenyl trichloro silane, 2-cyanoethyl trichloro silane, 2-cyanoethyl methyl dichloro silane, 3-cyanopropyl methyl diethoxy silane, 3-cyanopropyl methyl dichloro silane, 3-cyanopropyl methyl dichloro silane, 3-cyanopropyl dimethyl ethoxy silane, 3-cyanopropyl methyl dichloro silane, 3-cyanopropyl trichloro silane, fluorinated alkyl silane, and the like, and it is possible to use one type or a combination of two or more types which are selected from these.

Among these, it is preferable that hexamethyl disilazane is used in the hydrophobic processing. Due to this, it is possible for the particles 111 to have higher hydrophobicity. In addition, it is possible for uniformity of the extent of the hydrophobic processing to be higher for each of the particles 111 and each portion on the surface of the particles 111 (including the surfaces inside of the porous holes 1111) in an easy and reliable manner.

In a case where the hydrophobic processing is performed using a silane compound in a liquid phase, it is possible for a desired reaction to appropriately progress and it is possible to form a silane compound chemical absorption film by immersing the particles 111, where the hydrophobic processing is to be carried out, in a liquid which includes a silane compound.

In addition, in a case where the hydrophobic processing is performed using a silane compound in a gas phase, it is possible for a desired reaction to appropriately progress and it is possible to form a silane compound chemical absorption film by exposing the particles 111, where the hydrophobic processing is to be carried out, to the vapors of a silane compound.

The average particle diameter of the particles 111 which configure the three dimensional molding powder is not particularly limited but is preferably 1 μm or more and 25 μm or less and is more preferable 1 μm or more and 15 μm or less. Due to this, it is possible for the three dimensional mold object 10 to have particularly superior mechanical strength, for unintentional irregularities and the like to be more effectively prevented from being generated in the three dimensional mold object 10 which is manufactured, and for the three dimensional mold object 10 to have particularly superior dimensional precision. In addition, it is possible for fluidity of the three dimensional molding powder and fluidity of the composition (the particle-containing composition) 11 which includes the three dimensional molding powder to be particularly superior and it is possible for the three dimensional mold object 10 to have particularly superior productivity.

The maximum diameter of the particles 111 which configure the three dimensional molding powder is preferably 3 μm or more and 40 μm or less and is more preferably 5 μm or more and 30 μm or less. Due to this, it is possible for the three dimensional mold object 10 to have particularly superior mechanical strength, for unintentional irregularities and the like to be more effectively prevented from being generated in the three dimensional mold object 10 which is manufactured, and for the three dimensional mold object 10 to have particularly superior dimensional precision. In addition, it is possible for fluidity of the three dimensional molding powder and fluidity of the composition (the particle-containing composition) 11 which includes the three dimensional molding powder to be particularly superior and it is possible for the three dimensional mold object 10 to have particularly superior productivity.

The porosity of the particles 111 which configure the three dimensional molding powder is preferably 50% or more and is more preferably 55% or more and 90% or less. Due to this, it is possible for there to be sufficiently spaces (the porous holes 1111) into which the bonding agent enters and for the particles 111 to have particularly superior mechanical strength, and as a result, it is possible for the three dimensional mold object 10 to have particularly superior productivity due to the bonding agent 121 penetrating into the porous holes 1111. Here, the porosity of the particles in the present invention refers to the proportion of the holes which are inside of the particles (in terms of volume) with respect to the apparent volume of the particles and is a value which is represented by {(ρ₀−p)/ρ₀}×100 when the density of the particles is ρ (g/cm³) and the true density of the configuring material of the particles is ρ₀ (g/cm³).

The average hole diameter of the particles 111 (the diameter of the pores) is preferable 10 nm or more and is more preferably 50 nm or more and 300 nm or less. Due to this, it is possible for the three dimensional mold object 10 which is obtained as a final product to have particularly superior mechanical strength. In addition, in a case where the binding liquid 12 which includes a pigment (a color ink) is used in manufacturing the three dimensional mold object 10, it is possible for the pigment to be appropriately held in the porous holes 1111 of the particles 111. For this reason, it is possible to prevent unintentional dispersing of the pigment and it is possible to more reliably form high precision images.

The particles 111 which configure the three dimensional molding powder may have any shape but preferably have spherical shapes. Due to this, it is possible for fluidity of the three dimensional molding powder and fluidity of the composition (the particle-containing composition) 11 which includes the three dimensional molding powder to be particularly superior and it is possible for the three dimensional mold object 10 to have particularly superior productivity, and it is possible for unintentional irregularities and the like to be more effectively prevented from being generated in the three dimensional mold object 10 which is manufactured and for the three dimensional mold object 10 to have particularly superior dimensional precision.

The void ratio of the three dimensional molding powder is preferably 70% or more and 98% or less and is more preferably 75% or more and 97.7% or less. Due to this, it is possible for the three dimensional mold object 10 to have particularly superior mechanical strength. In addition, it is possible for fluidity of the three dimensional molding powder and fluidity of the composition (the particle-containing composition) 11 which includes the three dimensional molding powder to be particularly superior and it is possible for the three dimensional mold object 10 to have particularly superior productivity, and it is possible to more effectively prevent unintentional irregularities and the like being generated in the three dimensional mold object 10 which is manufactured and for the three dimensional mold object 10 to have particularly superior dimensional precision. Here, in a case where the inside of a vessel with a predetermined capacity (for example, 100 mL) is filled with the three dimensional molding powder, the void ratio of the three dimensional molding powder in the present invention refers to the ratio of the sum of the volume of the porous holes in all of the particles which configure the three dimensional molding powder and the volume of the voids which are between the particles with respect to the capacity of the vessel and is a value which is represented by {(P₀−P)/P₀}×100 when the bulk density of the three dimensional molding powder is P (g/cm³) and the true density of the configuring materials of the three dimensional molding powder is P₀ (g/cm³).

The content ratio of the three dimensional molding powder in the composition (the particle-containing composition) 11 is preferably 10% or more by mass and 90% or less by mass and is more preferably 15% or more by mass and 65% or less by mass. Due to this, it is possible for the fluidity of the composition (the particle-containing composition) 11 to be sufficiently superior and it is possible for the three dimensional mold object 10 which is obtained as a final product to have particularly superior mechanical strength.

### Water Soluble Resin

The composition 11 may include the water soluble resin 112 along with a plurality of the particles 111. Due to the water soluble resin 112 being included, the particles 111 are bonded (temporary fixed) together in portions of the layer 1 where the binding liquid 12 is not applied (refer to FIG. 8) and it is possible to effectively prevent unintentional scattering and the like of the particles 111. Due to this, it is possible to achieve an improvement in the safety of an operator and dimensional precision of the three dimensional mold object 10 which is manufactured. Even in a case where the water soluble resin 112 is included, the water soluble resin 112 is effectively prevented from entering into the porous holes 1111 of the particles 111 in a case where the hydrophobic processing is carried out on the particles 111. For this reason, it is possible to reliably exhibit the function of the water soluble resin 112 which is to temporarily fix together the particles 111 and to reliably prevent the problem, where it is not possible to secure the space into which the bonding agent 121 enters, being generated due to the water soluble resin 112 previously entering into the porous holes 1111 of the particles 111.

It is sufficient if at least a portion of the water soluble resin 112 is soluble in water and the solubility with respect to water at 25° C. (the amount which is able to be dissolved in 100 g of water) is preferably, for example, 5 (g/100 g of water) or more and is more preferably 10 (g/100 g of water) or more.

As the water soluble resin 112, there are the examples of, for example, synthetic polymers such as random copolymers of polyvinyl alcohol (PVA), polyvinyl pyrrolidone (PVP), polycaprolactam diol, sodium polyacrylate, polyacrylamide, modified polyamide, polyethylene imine, polyethylene oxide, ethylene oxide, and propylene oxide, natural polymers such as corn starch, mannan, pectin, agar, alginic acid, dextran, glue, and gelatin, semi-synthetic polymers such as carboxymethyl cellulose, hydroxyethyl cellulose, oxidized starch, and modified starches, and the like, and it is possible to use one type or a combination of two or more types which are selected from these.

As details examples of water soluble resin products, there are the examples of, for example, methyl cellulose

(METOLOSE SM-15 manufactured by Shin-Etsu Chemical Co., Ltd.), hydroxyethyl cellulose (AL-15 manufactured by Fuji Chemical Co., Ltd.), hydroxypropyl cellulose (HPC-M manufactured by Nippon Soda Co., Ltd.), carboxymethyl cellulose (CMC-30 manufactured by Nichirin Chemical Co., Ltd.), starch phosphate ester sodium (1) (HOSTER 5100 manufactured by Matsutani Chemical Industry Co., Ltd.), polyvinyl pyrrolidone (PVP K-90 manufactured by Tokyo Chemical Co., Ltd.), methyl vinyl ether/maleic anhydride copolymer (GANTREZ AN-139 manufactured by GAF Chemical Corp.), polyacrylamide (manufactured by Wako Pure Chemical Industries Ltd.), modified polyamide (modified nylon) (AQ nylon manufactured by Toray Industries Inc.), polyethylene oxide (PEO-1 manufactured by Seitetsu Kagaku Kogyo K.K. and ALKOX manufactured by Meisei Chemical Works, Ltd.), random copolymer of ethylene oxide and propylene oxide (ALKOX EP manufactured by Meisei Chemical Works, Ltd.), sodium polyacrylate (manufactured by Wako Pure Chemical Industries Ltd.), carboxy vinyl polymer/cross-linked water soluble acrylic resin (AQUPEC manufactured by Sumitomo Seika Chemicals Co., Ltd.), and the like.

Among these, it is possible for the three dimensional mold object 10 to have particularly superior mechanical strength in a case where the water soluble resin 112 is a polyvinyl alcohol. In addition, it is possible to more appropriately control the properties of the water soluble resin 112 (for example, solubility in water, water resistance, and the like) and the properties of the composition 11 (for example, viscosity, force for fixing of the particles 111, wettability, and the like) by adjusting the extent of saponification and polymerization. For this reason, it is possible to more appropriately correspond to manufacturing of various types of the three dimensional mold object 10. In addition, polyvinyl alcohols are cheaper and have a more stable supply among the various types of water soluble resins. For this reason, it is possible to perform stable manufacturing of the three dimensional mold object 10 while suppressing production costs.

In a case where the water soluble resin 112 includes polyvinyl alcohol, it is preferable that saponification of the polyvinyl alcohol be 85 or more and 90 or less. Due to this, it is possible to suppress a reduction in solubility of the polyvinyl alcohol with respect to water. For this reason, it is possible to more effectively suppress a reduction in adhesiveness between the layers 1 which are adjacent in a case where the composition 11 includes water.

In a case where the water soluble resin 112 includes polyvinyl alcohol, it is preferable that polymerization of the polyvinyl alcohol be 300 or more and 1000 or less. Due to this, it is possible to have particularly superior mechanical strength in each of the layers 1 and adhesiveness between the layers 1 which are adjacent in a case where the composition 11 includes water.

In addition, the following effects are obtained in a case where the water soluble resin 112 is a polyvinyl pyrrolidone (PVP). That is, since polyvinyl pyrrolidone has superior adhesiveness with respect to various materials such as glass, metals, and plastics, it is possible for the layer 1 where the binding liquid 12 is not applied to have particularly superior stability in the strength and shape of portions and for the three dimensional mold object 10 which is obtained as a final product to have particularly superior dimensional precision. In addition, since polyvinyl pyrrolidone exhibits high solubility with respect to various types of organic solvents, it is possible for fluidity of the composition 11 to be particularly superior in a case where the composition 11 includes an organic solvent, it is possible to appropriately form the layer 1 where unintentional variation in the thickness is more effectively prevented, and it is possible for the three dimensional mold object 10 which is obtained as a final product to have particularly superior dimensional precision. In addition, since polyvinyl pyrrolidone exhibits high solubility with respect to water, it is possible to easily and reliably remove the particles 111 which are not bonded using the bonding agent 121 out of the particles 111 which configure each of the layers 1 in the unbonded particles removing process (after manufacturing is complete). In addition, since polyvinyl pyrrolidone has appropriate affinity with the three dimensional molding powder, wettability with respect to the surface of the particles 111 is comparatively high while, on the other hand, it is sufficiently difficult for entering into the porous holes 1111 to occur as described above. For this reason, it is possible to more effectively exhibit the function of temporary fixing as described above. In addition, since polyvinyl pyrrolidone has superior affinity with respect to various types of coloring agents, it is possible to effectively prevent unintentional spreading of the coloring agent in a case where the binding liquid 12 which includes a coloring agent is used in the binding liquid applying process. In addition, since polyvinyl pyrrolidone has an anti-static function, it is possible to effectively prevent scattering of the particles in a case where the particles which are not in a paste are used as the composition 11 in the layer forming process. In addition, if the composition 11 in a paste form includes polyvinyl pyrrolidone in a case where the composition 11 is used as a paste in the layer forming process, it is possible to effectively prevent foam from being mixed into the composition 11 and it is possible to more effectively prevent defects due to the foam being mixed in being generated in the layer forming process.

In a case where the water soluble resin 112 includes polyvinyl pyrrolidone, the weight average molecular weight of the polyvinyl pyrrolidone is preferably 10000 or more and 1700000 or less and is preferably 30000 or more and 1500000 or less. Due to this, it is possible to more effectively exhibit the function described above.

In addition, in a case where the water soluble resin 112 includes polycaprolactam diol, it is possible for the composition 11 to be in appropriate pellet shapes, it is possible to more effectively prevent unintentional scattering of the particles 111 and the like, and it is possible to improve the handling (ease of handling) of the composition 11 and achieve an improvement in safety of the operator and dimensional precision of the three dimensional mold object 10 which is manufactured, and it is possible to suppress energy costs which are necessary in the production of the three dimensional mold object 10 and it is possible for the three dimensional mold object 10 to have sufficiently superior productivity since melting at a relatively low temperature is possible.

In a case where the water soluble resin 112 includes polycaprolactam diol, the weight average molecular weight of the polycaprolactam diol is preferably 10000 or more and 1700000 or less and is preferably 30000 or more and 1500000 or less. Due to this, it is possible to more effectively exhibit the function described above.

It is preferable that the water soluble resin 112 in the composition 11 be in a liquid phase state (for example, a dissolved state, a melted state, or the like) in at least the layer forming process. Due to this, it is possible for the uniformity of the thickness of the layers 1 which are formed using the composition 11 to be higher in an easy and reliable manner.

### Solvent

The composition 11 may include a volatile solvent in addition to the components described above. Due to this, it is possible for fluidity of the composition 11 to be particularly superior and for the three dimensional mold object 10 to have particularly superior productivity. It is possible to more effectively prevent unintentional scattering of the particles 111 and the like when forming the layer 1. In addition, in a case of using the composition for forming the layers includes the solvent in addition to the particles (the powder), problems are particularly remarkably generated in the prior art such as, when the layer which is new is formed by applying the composition onto the layer where the bonded section is formed, the composition is repelled in places, the composition slips on the bonded section during planarizing, and it is not possible to form the powder layers with highly uniform thickness, but it is possible to reliably prevent these problems from being generated in the present invention. That is, the effects of the present invention are more remarkably exhibited in a case where the composition includes the volatile solvent in addition to the particles.

It is preferable that the water soluble resin 112 be dissolved in the solvent. Due to this, it is possible for the composition 11 to have favorable fluidity and it is possible to more effectively prevent unintentional variation in the thickness of the layers 1 which are formed using the composition 11. In addition, it is possible for the water soluble resin 112 to be attached to the particles 111 with higher uniformity over the entirety of the layer 1 when the layer 1 is formed in a state where the solvent is removed and it is possible to more effectively prevent unintentional unevenness in the composition being generated. For this reason, it is possible to more effectively prevent unintentional variation in mechanical strength being generated at each portion of the three dimensional mold object 10 which is obtained as a result and it is possible for the three dimensional mold object 10 to have higher reliability. In addition, in a case where the composition for forming the layers includes the solvent and the water soluble resin in addition to the particles, problems such as described above are particularly remarkably generated in the prior art in a case where the solvent dissolves the water soluble resin, but it is possible to reliably prevent these problems from being generated in the present invention. That is, the effects of the present invention are more remarkable exhibited in a case where the solvent dissolves the water soluble resin 112 in the composition 11.

As the solvent which configures the composition 11, there are the examples of, for example, water, alcoholic solvents such as methanol, ethanol, and isopropanol, ketone solvents such as methyl ethyl ketone and acetone, glycol ether solvents such as ethylene glycol monoethyl ether and ethylene glycol monobutyl ether, glycol ether acetate solvents such as propylene glycol 1-monomethyl ether 2-acetate and propylene glycol 1-monomethyl ether 2-acetate, polyethylene glycol, polypropylene glycol, and the like, and it is possible to use one type or a combination of two or more types which are selected from these.

Among these, it is preferable that the composition 11 includes water. Due to this, it is possible for the water soluble resin 112 to be more reliably dissolved and it is possible for fluidity of the composition 11 and uniformity of the formation of the layers 1 which are formed using the composition 11 to be particularly superior. In addition, removing of water after forming the layer 1 is easy and it is difficult for there to be adverse effects even in a case where water remains in the three dimensional mold object 10. In addition, it is effective from the points of view of safety for people, environmental issues, and the like. In addition, in a case where the composition for forming the layers includes water, problems such as described above are particularly remarkably generated in the prior art, but it is possible to reliably prevent these problems from being generated in the present invention. That is, the effects of the present invention are more remarkable exhibited in a case where the composition 11 includes water.

The content ratio of the solvent in the composition 11 in a case where the composition 11 includes the solvent is preferably 5% or more by mass and 75% or less by mass and more preferably 35% or more by mass and 70% or less by mass. Due to this, since the effects from including the solvent as described above are more remarkably exhibited and it is possible for the solvent to be easily removed in a short period of time in the process of manufacturing the three dimensional mold object 10, it is effective from the point of view of improving productivity of the three dimensional mold object 10.

In particular, the content ratio of water in the composition 11 in a case where the composition 11 includes water as the solvent is preferably 20% or more by mass and 73% or less by mass and more preferably 50% or more by mass and 70% or less by mass. Due to this, the effects as described above are more remarkably exhibited.

### Other Compounds

In addition, the composition 11 may include compounds other than the compounds described above. As the other compounds, there are the examples of, for example, a polymerization initiator, a polymerization accelerator, a penetration enhancing agent, a wetting agent (a moisturizing agent), a fixing agent, an antimold agent, a preserving agent, an antioxidizing agent, an ultraviolet absorbing agent, a chelating agent, a pH adjusting agent, and the like.

### Three Dimensional Mold Object

It is possible for the three dimensional mold object of the present invention to be manufactured using the method of manufacturing and the three dimensional mold object manufacturing apparatus described above. Due to this, it is possible to provide the three dimensional mold object with superior dimensional precision and superior mechanical strength and durability.

The applications of the three dimensional mold object of the present invention are not particularly limited, but there are the examples of, for example, ornaments or exhibits such as figurines, medical devices such as implants, and the like.

In addition, the three dimensional mold object of the present invention may be applied to any of prototypes, mass production, or made-to-order products.

The appropriate embodiments of the present invention are described above, but the present invention is not limited to this.

For example, a roller or the like may be used as the planarizing part instead of the squeegee as described above.

In addition, there is a configuration in the embodiments described above where the space where there is the binding liquid discharging section (the binding liquid applying part) and the space where there is the modifying part are separated by moving the wall section, which is disposed so as to surround the irradiating section of the modifying part, along with the modifying part, but the means which separates the space where there is the binding liquid discharging section (the binding liquid applying part) and the space where there is the modifying part is not limited to this and the spaces may be separated by a shutter.

In addition, the three dimensional mold object manufacturing apparatus may be provided with a recovery mechanism which is not shown in the diagrams for recovering the composition which is not used in forming the layers out of the composition which is supplied from the composition supplying section. Due to this, since it is possible to supply the composition in a sufficient amount while preventing surplus composition accumulating in the layer forming section, it is possible to more stably manufacture the three dimensional mold object while more effectively preventing defects being generated in the layers. In addition, since it is possible to use the composition which is recovered again in manufacturing the three dimensional mold object, it is possible to contribute to a reduction in manufacturing costs of the three dimensional mold object and, in addition, it is preferable from the point of view of saving resources.

In addition, the three dimensional mold object manufacturing apparatus of the present invention may be provided with a recovery mechanism for recovering the composition which is removed in the unbonded particles removing process.

In addition, it is described that the bonded sections are formed with respect to all of the layers in the embodiments described above, but there may be layers where the bonded section is not formed. For example, the layer which is formed directly on the stage so that the bonded section is not formed may function as a sacrificial layer.

In addition, the binding liquid applying process in the embodiments described above is described centered on a case of being performed using an ink jet system, but the binding liquid applying process may be performed using another method (for example, another printing method).

In addition, there may be a configuration in the three dimensional mold object manufacturing apparatus of the present invention where there are spaces where the layer forming section, the curing part, and the modifying part are independent (spaces which separate using a partition wall or the like), and the layers which are formed are sequentially transported from the layer forming section to a region where the curing part is provided and to a region where the modifying part is provided.

In addition, it is described in the embodiments described above that forming of the bonded section is performed using the binding liquid, but forming of the bonded section may be performed using any method in the present invention and may be performed by, for example, fusing (sintering and joining) the particles by irradiating energy rays.

In addition, it is sufficient if the modification processing is performed in the present invention with respect to at least a portion of the layer (the layer where the bonded section is formed) out of the plurality of layers which configure the three dimensional mold object and the modification processing need not be performed with respect to all of the layers.

In addition, a pre-processing process, an intermediate processing process, and a post-processing process may be performed in the manufacturing method of the present invention according to requirements.

As the pre-processing process, there are the examples of, for example, a stage cleaning process or the like.

As the intermediate processing process, there may be a process where, for example, heating is stopped or the like (a water soluble resin solidifying process) between the layer forming process and the binding liquid applying process in a case where the particle-containing composition is in pellet form. Due to this, the water soluble resin is in a solid state and it is possible to obtain the layers with a stronger force for bonding the particles together. In addition, there may be a solvent component removing process where, for example, in a case where the particle-containing composition includes a solvent component (dispersing agent) such as water, the solvent component is removed between the layer forming process and the binding liquid applying process. Due to this, it is possible to more smoothly perform the layer forming process and it is possible to more effectively prevent unintentional variation in the thickness of the layers which are formed. As a result, it is possible for the three dimensional mold object with higher dimensional precision to be manufactured with higher productivity.

As the post-processing process, there are the examples of, for example, a washing process, a shape adjusting process where trimming is performed, a coloring process, a cover layer forming process, a bonding agent curing completion process where light irradiation processing or heat processing is performed in order to reliably cure the bonding agent which is not cured, and the like.

In addition, there is description of the embodiments described above centered on the method which has the binding liquid applying process and the curing process (the bonding process), but it is not necessary to provide the curing process (the bonding process) after the binding liquid applying process in a case where the binding liquid includes a thermoplastic resin as the bonding agent (and it is possible for the binding liquid applying process to be carried out together with the bonding process). In addition, the three dimensional mold object manufacturing apparatus need not be provided with the energy ray irradiating part (the curing part) in this case.

In addition, atmospheric pressure plasma may be used as the modifying part instead of the ultraviolet ray irradiating part which irradiates ultraviolet rays. In detail, irradiating of oxygen in a plasma state is performed from a plasma discharge electrode. As the conditions of the O₂ plasma processing, for example, the plasma power is 50 W or more and 1000 W or less and the flow amount of oxygen gas is 50 ml/min or more and 100 ml/min or less.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A three dimensional mold object manufacturing apparatus adapted to manufacture a three dimensional mold object by repeatedly forming and layering layers using a composition including particles, the three dimensional mold object manufacturing apparatus comprising:
a layer forming section configured and arranged to form the layers using the composition;
a bonded section forming part configured and arranged to bond the particles included in a predetermined region in at least one of the layers to form a bonded section; and
a modifying part configured and arranged to carry out modification processing with respect to the at least one of the layers where the bonded section is formed before a subsequent one of the layers is formed on the at least one of the layers.

2. The three dimensional mold object manufacturing apparatus according to claim 1, wherein
the modifying part has an energy ray irradiating part configured and arranged to irradiate energy rays with respect to the at least one of the layers where the bonded section is formed.

3. The three dimensional mold object manufacturing apparatus according to claim 2, wherein
the energy rays are ultraviolet rays with a peak wavelength of 1 nm or more and 330 nm or less.

4. The three dimensional mold object manufacturing apparatus according to claim 2, wherein
an area of an irradiating region irradiated by an irradiating section for energy rays in the energy ray irradiating part is larger than an area of the at least one of the layers.

5. The three dimensional mold object manufacturing apparatus according to claim 1, wherein
the modifying part has a modifying agent applying part configured and arranged to apply a modifying agent.

6. The three dimensional mold object manufacturing apparatus according to claim 1, wherein
the modifying part is configured and arranged to perform atmospheric pressure plasma processing.

7. The three dimensional mold object manufacturing apparatus according to claim 1, wherein
the bonded section forming part includes a binding liquid applying part configured and arranged to apply a binding liquid for bonding the particles.

8. The three dimensional mold object manufacturing apparatus according to claim 7, wherein
the bonded section forming part includes a curing part configured and arranged to cure a curable component included in the binding liquid.

9. The three dimensional mold object manufacturing apparatus according to claim 7, wherein
the modifying part is configured and arranged to carry out the modification processing in a state where the binding liquid applying part is arranged in a space separated from the modifying part so that the binding liquid applying part is not influenced by the modifying part.

10. The three dimensional mold object manufacturing apparatus according to claim 1, further comprising
a scanning part configured and arranged to scan a state of the at least one of the layers where the modification processing is carried out.

11. The three dimensional mold object manufacturing apparatus according to claim 1, wherein
the composition includes a volatile solvent and a water soluble resin in addition to the particles.

12. The three dimensional mold object manufacturing apparatus according to claim 1, wherein
the particles are porous and subject to hydrophobic processing.

13. A method for manufacturing a three dimensional mold object comprising:
manufacturing the three dimensional mold object using the three dimensional mold object manufacturing apparatus according to claim 1.

14. A method for manufacturing a three dimensional mold object comprising:
forming a layer with a predetermined thickness using a composition including particles;
bonding the particles included in a predetermined region of the layer and forming a bonded section;
repeating the forming and the bonding to form a plurality of the layers constituting the three dimensional mold object; and
carrying out modification processing with respect to at least one of the layers where the bonded section is formed after the bonding of the particles in the at least one of the layers and before the forming of a subsequent one of the layers on a surface of the at least one of the layers where the bonded section is formed.

15. The method for manufacturing a three dimensional mold object according to claim 14, wherein
the bonding includes applying a binding liquid including a bonding agent, with respect to the at least one of the layers using an ink jet system and curing the bonding agent in the binding liquid applied to the layer.

16. A three dimensional mold object manufactured using the three dimensional mold object manufacturing apparatus according to claim 1.
